(19) United States
(12) Patent Application Publication
(10) Pub. No.: US 2026/0252543 A1
(43) Pub. Date: Aug. 27, 2026

(54) SYSTEM

(71) Applicant: SoftBank Group Corp., Tokyo (JP)

(72) Inventor: Tsutomu IKUMI, Tokyo (JP)

(73) Assignee: SoftBank Group Corp., Tokyo (JP)

(21) Appl. No.: 19/542,701

(22) Filed: Feb. 18, 2026

(30) Foreign Application Priority Data
Feb. 21, 2025 (JP) 2025-026984

(51) Int. Cl. G06F 16/22; G06F 16/242; G06F 16/28

(52) U.S. Cl. CPC G06F 16/2272; G06F 16/2237; G06F 16/243; G06F 16/285

(57) ABSTRACT

The system according to the embodiment comprises a learning unit, an extraction unit, an addition unit, and a generation unit. The learning unit learns from past project plans. The extraction unit extracts content that can be standardized based on the content learned by the learning unit. The addition unit adds specific content based on the standardized content extracted by the extraction unit. The generation unit generates a draft version of a project plan by combining the specific content added by the addition unit with the standardized content.

### CROSS-REFERENCE TO RELATED APPLICATION

The present application claims priority to and incorporates by reference the entire contents of Japanese Patent Application No. 2025-026984 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, in the creation of project plans, efficient extraction of content that can be standardized and combination with specific content have not been sufficiently performed, leaving room for improvement.

### SUMMARY OF THE INVENTION

The system according to the embodiment comprises a learning unit, an extraction unit, an addition unit, and a generation unit. The learning unit learns from past project plans. The extraction unit extracts content that can be standardized based on the content learned by the learning unit. The addition unit adds specific content based on the standardized content extracted by the extraction unit. The generation unit generates a draft version of a project plan by combining the specific content added by the addition unit with the standardized content.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

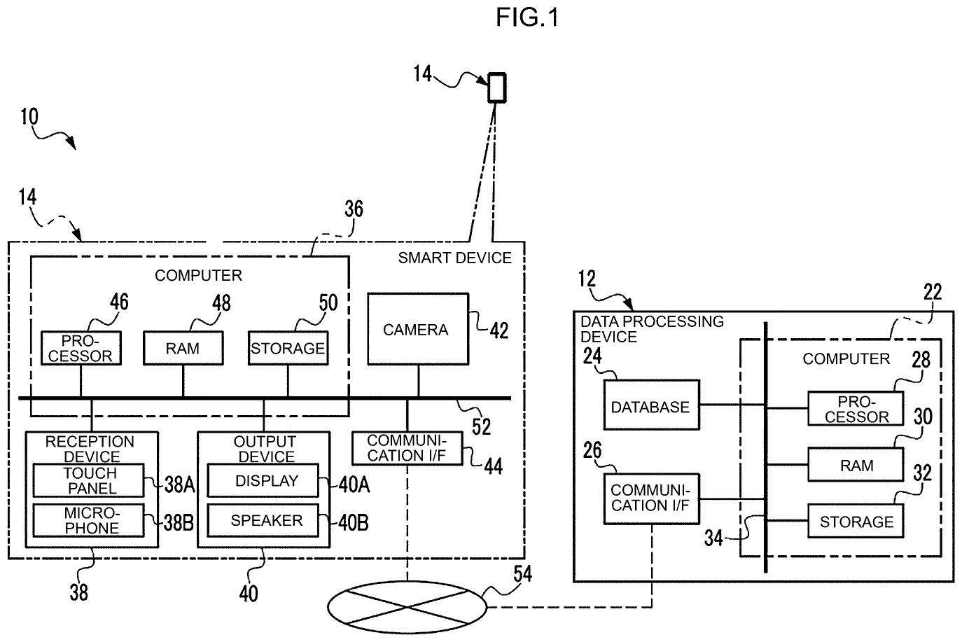

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

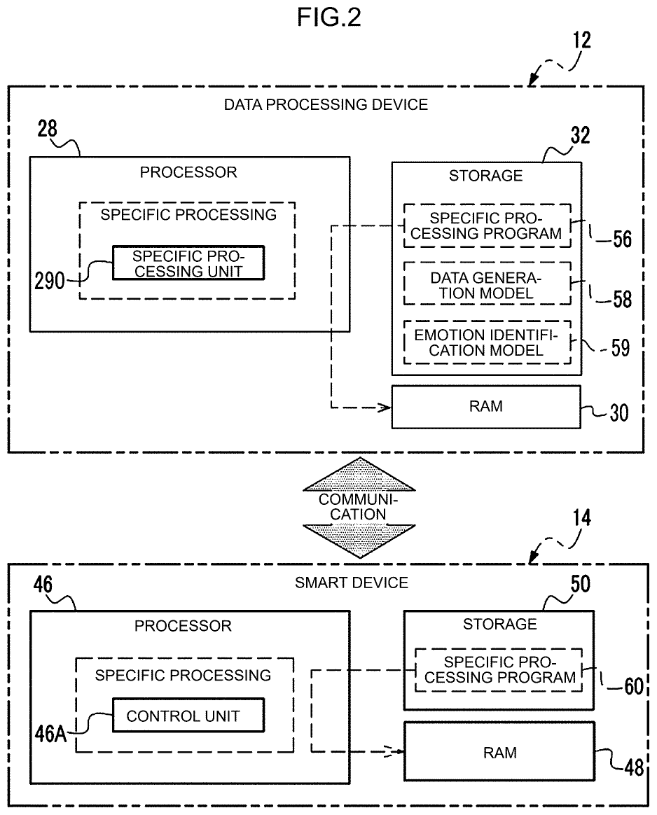

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The project plan creation system according to the embodiment of the present invention is a system that learns from past project plans, extracts standardized content and specific content, and generates a draft version of a project plan by combining these contents. This system learns from past project plans, extracts content that can be standardized, adds specific content for the customer, and generates a draft version of a project plan. For example, when learning from past project plans, a generative AI is used to analyze the content of the plans and classify standardized content and specific content. The generative AI distinguishes between standardized content such as project objectives, schedules, and resource allocation, and specific content such as customer requirements and specific technical requirements. Next, based on the learned content, standardized content is extracted. The generative AI automatically extracts portions that can be standardized from past plans and saves them as templates. This enables rapid incorporation of standardized portions when creating new project plans. Furthermore, specific content for the customer is added. The generative AI analyzes customer requirements and specific technical requirements and adds them to the template. For example, specific functions or services requested by the customer, as well as technical constraints, are reflected in the plan. Finally, the generative AI combines standardized content and specific content to generate a draft version of a project plan. This draft version includes the project objectives, schedule, resource allocation, customer requirements, and so on, and helps to grasp the overall picture of the project. As a result, the creation of project plans is streamlined and the quality is improved. By using generative AI, it is possible to quickly create plans that utilize insights from past plans while responding to customer requirements. For example, standardized portions such as project objectives, schedules, and resource allocation can be saved as templates, and customer requirements and specific technical requirements can be added to generate a draft version of a project plan. Thus, the project plan creation system can streamline the creation of project plans and improve their quality. Specifically, this project plan creation system first receives a large amount of past project plan data (e.g., text files, PDFs, structured databases) as input data. The system performs preprocessing to convert these plan data into token sequences or context vectors for natural language processing (for example, 768-dimensional vectors by BERT or Transformer-based encoders). Next, the system uses a text generation-type large language model (for example, a multi-layer Transformer encoder-decoder structure with billions of parameters) to extract features such as “project objective,” “schedule,” “resource allocation,” “customer requirements,” and “technical requirements” for each section of the plan. Examples of input to the AI include text data such as “Full text of the 2022 system development plan for Company A” and “Full text of the 2021 infrastructure construction plan for Company B.” Examples of AI output include structured tag data such as “Standardizable: Project Objective=New System Introduction, Schedule=6 months, Resource Allocation=1 PM/3 SE/5 PG” and “Specific: Customer Requirement=Cloud integration required, Technical Requirement=Specific OS support.” The system stores these outputs in a template database for reusable standardized portions and manages specific portions as customization data for each customer. When generating templates, the AI automatically extracts common portions such as “project objective” and “schedule” and saves them as structured templates such as JSON or XML. When adding customer requirements or technical requirements, the AI receives requirement input from the customer (e.g., text such as “cloud integration,” “security requirements”) and merges it into the template. The AI output is ultimately provided as a “draft version of a project plan” in formats such as text files, PDFs, or Word documents. In subsequent processing, the generated draft version can be reviewed by a human project manager, who may provide correction instructions to the AI as feedback if necessary. As a technical effect, this system can greatly reduce the time required for plan creation compared to conventional manual creation by automatically extracting and reusing common portions, and can reduce human error and omissions. In addition, classification and extraction processing in a high-dimensional feature space by AI enables template creation while maintaining contextual and semantic consistency, which improves the quality and reproducibility of plans compared to simple copy-paste or rule-based processing by humans. Applicable fields include IT system development, construction projects, production planning in manufacturing, research and development projects, and other industries where multiple plan creations occur repeatedly. Furthermore, as learning methods for the AI model, a combination of multiple algorithms can be used, such as section classification by supervised learning, context feature extraction by self-supervised learning, and template optimization by reinforcement learning. Thus, the project plan creation system achieves not only automation but also technical improvement and efficiency of the plan creation process itself.

The project plan creation system according to the embodiment comprises a learning unit, an extraction unit, an addition unit, and a generation unit. The learning unit learns from past project plans. For example, the learning unit analyzes the content of past project plans and classifies standardized content and specific content. The learning unit uses a generative AI to analyze the content of past project plans. The generative AI, for example, uses a text generation AI (such as an LLM) to analyze the content of project plans and classify standardized content and specific content. The generative AI distinguishes between standardized content such as project objectives, schedules, and resource allocation, and specific content such as customer requirements and specific technical requirements. The extraction unit extracts standardized content based on the content learned by the learning unit. For example, the extraction unit automatically extracts portions that can be standardized from past plans and saves them as templates. The extraction unit uses a generative AI to automatically extract portions that can be standardized from past plans and save them as templates. The generative AI, for example, uses machine learning algorithms to extract portions that can be standardized from past plans. The generative AI analyzes the content of past plans, extracts standardized portions, and saves them as templates. The addition unit adds specific content based on the standardized content extracted by the extraction unit. For example, the addition unit analyzes customer requirements or specific technical requirements and adds them to the template. The addition unit uses a generative AI to analyze customer requirements or specific technical requirements and add them to the template. The generative AI, for example, analyzes specific functions or services requested by the customer, as well as technical constraints, and adds them to the template. The generation unit combines the specific content added by the addition unit with the standardized content to generate a draft version of a project plan. For example, the generation unit combines standardized content and specific content to generate a draft version of a project plan. The generation unit uses a generative AI to combine standardized content and specific content to generate a draft version of a project plan. The generative AI, for example, uses a text generation AI to combine standardized content and specific content to generate a draft version of a project plan. As a result, the project plan creation system according to the embodiment can streamline the creation of project plans and improve their quality. Some or all of the above-described processing in the generation unit may be performed using AI or may be performed without using AI. For example, the generation unit may use an AI model that combines standardized content and specific content to generate a draft version of a project plan. Specifically, this project plan creation system prepares a server cluster equipped with a large language model as the learning unit and receives past project plans (e.g., text files, PDFs, structured databases) as input data. The learning unit performs preprocessing to convert these plan data into token sequences or context vectors for natural language processing (for example, 768-dimensional vectors by Transformer-based encoders). The learning unit uses a text generation-type large language model (for example, a multi-layer Transformer encoder-decoder structure with billions of parameters) to extract features such as “project objective,” “schedule,” “resource allocation,” “customer requirements,” and “technical requirements” for each section of the plan. Examples of input to the AI include text data such as “Full text of the 2022 system development plan for Company A” and “Full text of the 2021 infrastructure construction plan for Company B.” Examples of AI output include structured tag data such as “Standardizable: Project Objective=New System Introduction, Schedule=6 months, Resource Allocation=1 PM/3 SE/5 PG” and “Specific: Customer Requirement=Cloud integration required, Technical Requirement=Specific OS support.” The extraction unit stores these outputs in a template database for reusable standardized portions and manages specific portions as customization data for each customer. When generating templates, the extraction unit automatically extracts common portions such as “project objective” and “schedule” and saves them as structured templates such as JSON or XML. When adding customer requirements or technical requirements, the addition unit receives requirement input from the customer (e.g., text such as “cloud integration,” “security requirements”) and merges it into the template. The AI output is ultimately provided as a “draft version of a project plan” in formats such as text files, PDFs, or Word documents. In subsequent processing, the generated draft version can be reviewed by a human project manager, who may provide correction instructions to the AI as feedback if necessary. As a technical effect, this system can greatly reduce the time required for plan creation compared to conventional manual creation by automatically extracting and reusing common portions, and can reduce human error and omissions. In addition, classification and extraction processing in a high-dimensional feature space by AI enables template creation while maintaining contextual and semantic consistency, which improves the quality and reproducibility of plans compared to simple copy-paste or rule-based processing by humans. Applicable fields include IT system development, construction projects, production planning in manufacturing, research and development projects, and other industries where multiple plan creations occur repeatedly. Furthermore, as learning methods for the AI model, a combination of multiple algorithms can be used, such as section classification by supervised learning, context feature extraction by self-supervised learning, and template optimization by reinforcement learning. Thus, this project plan creation system achieves not only automation but also technical improvement and efficiency of the plan creation process itself.

The learning unit can analyze the content of past project plans. For example, the learning unit analyzes the content of past project plans. The learning unit uses a generative AI to analyze the content of past project plans. The generative AI, for example, uses a text generation AI (such as an LLM) to analyze the content of past project plans. The generative AI distinguishes between standardized content such as project objectives, schedules, and resource allocation, and specific content such as customer requirements and specific technical requirements. By analyzing the content of past project plans, standardized content and specific content can be classified. Some or all of the above-described processing in the learning unit may be performed using AI or may be performed without using AI. For example, the learning unit may use an AI model that analyzes the content of past project plans to analyze the content of past project plans. Specifically, the learning unit receives various formats of data such as text files, PDFs, and structured databases of past project plans as input data. The learning unit performs preprocessing to convert these data into token sequences or context vectors for natural language processing (e.g., 768-dimensional vectors by Transformer encoders). The learning unit uses a text generation-type large language model (for example, a multi-layer Transformer encoder-decoder structure with billions of parameters) to extract features such as “project objective,” “schedule,” “resource allocation,” “customer requirements,” and “technical requirements” for each section of the plan. Examples of input to the AI include text data such as “Full text of the 2022 system development plan for Company A” and “Full text of the 2021 infrastructure construction plan for Company B.” Examples of AI output include structured tag data such as “Standardizable: Project Objective=New System Introduction, Schedule=6 months, Resource Allocation=1 PM/3 SE/5 PG” and “Specific: Customer Requirement=Cloud integration required, Technical Requirement=Specific OS support.” The learning unit stores these outputs in a template database for reusable standardized portions and manages specific portions as customization data for each customer. Internal processing of the AI model may combine multiple algorithms, such as context feature extraction by self-supervised learning, section classification by supervised learning, and template optimization by reinforcement learning. As a result, the learning unit achieves classification and extraction in a high-dimensional feature space with semantic consistency, which is different from simple copy-paste or rule-based processing by humans, and brings technical improvements to the plan creation process (reduction of creation time, reduction of human error, improvement of quality). Applicable fields include IT system development, construction projects, production planning in manufacturing, research and development projects, and other industries where multiple plan creations occur repeatedly.

The extraction unit can automatically extract portions that can be standardized from past plans and save them as templates. For example, the extraction unit automatically extracts portions that can be standardized from past plans and saves them as templates. The extraction unit uses a generative AI to automatically extract portions that can be standardized from past plans and save them as templates. The generative AI, for example, uses machine learning algorithms to extract portions that can be standardized from past plans. The generative AI analyzes the content of past plans, extracts standardized portions, and saves them as templates. By saving standardized portions as templates, new project plans can be created quickly. Some or all of the above-described processing in the extraction unit may be performed using AI or may be performed without using AI. For example, the extraction unit may use an AI model that extracts portions that can be standardized from past plans to extract standardized portions and save them as templates. Specifically, the extraction unit receives feature data extracted by the learning unit (e.g., tagged structured data such as project objective, schedule, resource allocation) as input. The extraction unit uses frequency analysis algorithms or clustering methods (e.g., K-means clustering, principal component analysis) to automatically extract elements that commonly appear across multiple plans. The extraction unit saves the extracted common portions as structured templates such as JSON or XML in a database. Examples of input to the AI include “feature lists for each section extracted from plans over multiple years” and “tagged text data.” Examples of AI output include reusable template data such as “Template: Project Objective=New Introduction, Schedule=6 months, Resource Allocation=Standard Configuration.” When generating templates, the extraction unit enables rapid reuse in subsequent plan creation by automatically extracting common portions such as “project objective” and “schedule” and saving them as structured templates. As a technical effect, the extraction unit achieves reduction of creation time, reduction of omissions, and homogenization of plan quality by automatic extraction in a high-dimensional feature space, which is different from manual copy-paste or rule-based processing. Applicable fields include IT system development, construction, manufacturing, research and development, and other industries where efficiency through templating is required.

The addition unit can analyze customer requirements or specific technical requirements and add them to the template. For example, the addition unit analyzes customer requirements or specific technical requirements and adds them to the template. The addition unit uses a generative AI to analyze customer requirements or specific technical requirements and add them to the template. The generative AI, for example, analyzes specific functions or services requested by the customer, as well as technical constraints, and adds them to the template. By adding customer requirements or specific technical requirements to the template, plans tailored to the customer can be created. Some or all of the above-described processing in the addition unit may be performed using AI or may be performed without using AI. For example, the addition unit may use an AI model that analyzes customer requirements or specific technical requirements to analyze customer requirements or specific technical requirements and add them to the template. Specifically, the addition unit receives requirement data input by the customer (e.g., text such as “cloud integration required,” “specific OS support,” “security requirements”) as input. The addition unit uses natural language processing algorithms (e.g., BERT or Transformer-based encoders) to vectorize the requirement text and evaluate its relevance to existing templates. The addition unit performs classification of requirements (e.g., functional requirements, non-functional requirements, constraints) and prioritization, and automatically merges them into the relevant sections of the template. Examples of input to the AI include text data such as “Customer Requirement: Cloud integration required” and “Technical Requirement: Specific OS support.” Examples of AI output include structured data such as “Template update: Cloud integration function added, OS support requirement added.” During the merge process, the addition unit also automatically performs duplicate elimination and consistency checks of requirements. As a technical effect, the addition unit greatly improves work efficiency and reduces human error and omissions by automatic classification and merging of requirements compared to manual addition and editing. Applicable fields include IT system development, contract development, and custom product design in manufacturing, where different requirements frequently arise for each customer.

The generation unit can combine standardized content and specific content to generate a draft version of a project plan. For example, the generation unit combines standardized content and specific content to generate a draft version of a project plan. The generation unit uses a generative AI to combine standardized content and specific content to generate a draft version of a project plan. The generative AI, for example, uses a text generation AI to combine standardized content and specific content to generate a draft version of a project plan. By combining standardized content and specific content, the generation unit can efficiently generate a draft version of a project plan. Some or all of the above-described processing in the generation unit may be performed using AI or may be performed without using AI. For example, the generation unit may use an AI model that combines standardized content and specific content to generate a draft version of a project plan. Specifically, the generation unit receives template data generated by the extraction unit and customer-specific requirement data merged by the addition unit as input. The generation unit uses a text generation-type large language model (e.g., a multi-layer Transformer encoder-decoder structure) to automatically generate each section of the template (e.g., project objective, schedule, resource allocation, customer requirements, technical requirements) as logical and consistent sentences. To maintain contextual consistency and consistency of expression between sections, the generation unit utilizes autoregressive generation algorithms and attention mechanisms. Examples of input to the AI include structured data such as “Template: Project Objective=New Introduction, Schedule=6 months, Resource Allocation=Standard Configuration” and “Additional Requirements: Cloud integration required, Specific OS support.” Examples of AI output include natural language text or files in PDF or Word format such as “Draft version of project plan: Objective=New Introduction, Schedule=6 months, Resource Allocation=1 PM/3 SE/5 PG, Requirements=Cloud integration required, Specific OS support.” The generation unit outputs the generated results in formats such as text files, PDFs, or Word documents, and can also respond to subsequent review or correction instructions. As a technical effect, the generation unit can automatically ensure contextual consistency and quality of description, and greatly reduce creation time compared to manual editing or copy-paste work. Applicable fields include IT system development, construction, manufacturing, research and development, and other industries where multiple plan creations occur repeatedly.

The generation unit can output the generated draft version. For example, the generation unit outputs the generated draft version. The generation unit uses a generative AI to output the generated draft version. The generative AI, for example, outputs the draft version in formats such as PDF, print, or email transmission. By outputting the generated draft version, confirmation and correction of the project plan become easier. Some or all of the above-described processing in the generation unit may be performed using AI or may be performed without using AI. For example, the generation unit may use an AI model that outputs the generated draft version to output the draft version. Specifically, the generation unit passes the project plan draft version generated by the AI (e.g., natural language text, PDF, Word file) to an output format conversion module. The generation unit outputs the draft version via a user interface or API in formats such as PDF, Word, HTML, print data, or email attachments. The generation unit can also add metadata such as version control information, timestamps, and author information at the time of output. Examples of input to the AI include “Generated plan draft version (text format)” and “Output format specification: PDF.” Examples of AI output include document data such as “PDF file,” “Word file,” and “HTML file.” After output, the generated draft version can be reviewed by a human project manager, who may provide correction instructions to the AI as feedback. As a technical effect, the generation unit achieves efficiency and improved traceability in the confirmation, correction, and sharing process by automatic conversion of output formats and addition of metadata, compared to manual file conversion and output work. Applicable fields include IT system development, construction, manufacturing, research and development, and other industries where electronic distribution and review of plans are required.

The learning unit can estimate a user's emotion and select learning data based on the estimated emotion of the user. For example, the learning unit estimates a user's emotion and selects learning data based on the estimated emotion. The learning unit uses a generative AI to estimate a user's emotion. The generative AI, for example, uses an emotion estimation algorithm to estimate a user's emotion. The generative AI analyzes data such as the user's facial expressions, voice, and text to calculate an emotion score. For example, if the user is feeling stressed, learning data with relaxing content is preferentially selected. If the user is focused, learning data containing detailed technical information is selected. If the user is tired, concise and easy-to-understand learning data is selected. By selecting learning data based on the user's emotion, learning suitable for the user becomes possible. Emotion estimation is realized, for example, by using an emotion engine or a generative AI with emotion estimation functionality. The generative AI may be a text generation AI (such as an LLM) or a multimodal generative AI, but is not limited to these examples. Some or all of the above-described processing in the learning unit may be performed using AI or may be performed without using AI. For example, the learning unit may use an AI model that estimates a user's emotion to estimate the user's emotion and select learning data. Specifically, the learning unit simultaneously receives multimodal input data for emotion estimation (e.g., RGB tensor of facial images (224×224×3), time-series array of voice waveform (sampling rate 16 kHz, length 2 seconds), token sequence of chat text (up to 512 tokens)). For facial images, the learning unit uses a convolutional neural network (CNN) to extract facial features (e.g., eye opening/closing, mouth corner movement, eyebrow shape), for voice data, it extracts prosodic features (e.g., pitch, speech rate, intonation) using spectrogram conversion followed by a recurrent neural network (RNN) or Transformer encoder, and for text data, it generates context feature vectors using a pre-trained large language model (e.g., multi-layer Transformer encoder). The learning unit integrates these feature vectors with a multilayer perceptron (MLP) and finally outputs an “emotion score” (e.g., stress level 0.85, concentration level 0.60, fatigue level 0.30, as continuous values from 0 to 1). Examples of input to the AI include “Facial image: smiling, Voice: low tone and slow, Text: ‘I'm a little tired today’” and “Facial image: serious expression, Voice: clear speech, Text: ‘I want to read detailed materials.’” Examples of AI output include emotion score vectors such as “Stress level 0.80, concentration level 0.20, fatigue level 0.70” and “Stress level 0.10, concentration level 0.90, fatigue level 0.10.” The learning unit uses these emotion scores for threshold judgment (e.g., if stress level>0.7, prioritize relaxing learning data; if concentration level>0.8, prioritize detailed technical information; if fatigue level>0.6, prioritize summary materials) and automatically selects data of the relevant category (e.g., for relaxation: introductory materials focused on diagrams; for concentration: detailed technical papers; for fatigue: summary materials) from the learning database. Internal processing of the AI model for emotion estimation uses cross-entropy loss or MSE loss functions and can combine supervised learning (e.g., emotion-labeled datasets) and self-supervised learning (e.g., multimodal contrastive learning). As a technical effect, the learning unit maximizes learning efficiency, reduces user dropout rate, and improves learning outcomes by automatically selecting optimal learning data according to the user's real-time emotional state, which is different from conventional uniform learning data presentation. Applicable fields include e-learning for IT engineers, corporate training, medical professional education, school education, and other education and training fields where individual optimization is required. Furthermore, variations of emotion estimation AI include estimation using only facial images, only voice, only text, or multimodal estimation combining these, and the configuration can be flexibly changed according to the usage environment and privacy requirements. Thus, the learning unit achieves not only automation but also qualitative improvement of user experience and technical improvement of the learning process.

The learning unit can analyze the success rate of past project plans during learning and learn the characteristics of successful plans. For example, the learning unit analyzes the success rate of past project plans during learning and learns the characteristics of successful plans. The learning unit uses a generative AI to analyze the success rate of past project plans. The generative AI, for example, uses a text generation AI (such as an LLM) to analyze the success rate of past project plans. The generative AI extracts commonalities of successful project plans and incorporates them as learning data. For example, the learning unit analyzes the components of plans with high success rates and reflects them in the learning data. The learning unit learns methods of resource allocation and schedule management for successful plans. By learning the characteristics of successful plans, plans with a high success rate can be created. Some or all of the above-described processing in the learning unit may be performed using AI or may be performed without using AI. For example, the learning unit may use an AI model that analyzes the success rate of past project plans to learn the characteristics of successful plans. Specifically, the learning unit receives past project plan data (e.g., text files, PDFs, structured databases) and performance indicators for each project (e.g., on-time delivery rate, completion within budget rate, customer satisfaction score as numerical vectors) as input. The learning unit converts the plan text into token sequences or context vectors for natural language processing (e.g., 768-dimensional vectors by Transformer encoders) and manages performance indicators as normalized numerical vectors. The learning unit uses supervised learning algorithms (e.g., random forest, gradient boosting, or multilayer perceptron) to analyze the correlation between plan features and success rate. Examples of input to the AI include “Plan text: System development plan for Company A, Performance indicators: On-time delivery 1.0, Within budget 0.9, Customer satisfaction 4.5” and “Plan text: Infrastructure construction plan for Company B, Performance indicators: On-time delivery 0.7, Within budget 0.8, Customer satisfaction 3.2.” Examples of AI output include structured tag data such as “Success features: Resource allocation=1 PM/3 SE/5 PG, Schedule=6 months, Emphasis on requirements definition” and “Failure features: Resource allocation=0.5 PM/1 SE/2 PG, Schedule=3 months, Omission of requirements definition.” The learning unit stores success features in the template database and preferentially utilizes them when generating future plans. Internal processing of the AI model uses feature importance analysis (e.g., SHAP values, permutation importance) to visualize which elements contribute to the success rate and enhance model explainability. In subsequent processing, the extraction unit and generation unit refer to this success feature template and automatically reflect it when creating new plans. As a technical effect, the learning unit achieves improvement of plan success rate, homogenization of quality, and efficiency of creation by extracting and reusing success patterns based on objective data analysis, which is different from plan creation based on empirical rules or personal know-how. Applicable fields include IT system development, construction, manufacturing, research and development, and other project-based operations with clear performance indicators. Furthermore, variations of the AI model include time-series analysis for success prediction during project progress and anomaly detection algorithms for early detection of failure signs. Thus, the learning unit achieves not only automation but also technical improvement of the plan creation process and maximization of results.

The learning unit can apply different learning algorithms according to the scale or industry of the project during learning. For example, the learning unit applies different learning algorithms according to the scale or industry of the project during learning. The learning unit uses a generative AI to apply different learning algorithms according to the scale or industry of the project. The generative AI, for example, uses a text generation AI (such as an LLM) to apply different learning algorithms according to the scale or industry of the project. The generative AI applies learning algorithms for large-scale projects to create detailed plans. For example, learning algorithms for small-scale projects are applied to create concise plans. Industry-specific learning algorithms are applied to create plans that reflect industry-specific requirements. By applying learning algorithms according to the scale or industry of the project, appropriate plans can be created. Some or all of the above-described processing in the learning unit may be performed using AI or may be performed without using AI. For example, the learning unit may use an AI model that applies different learning algorithms according to the scale or industry of the project to apply different learning algorithms according to the scale or industry of the project. Specifically, the learning unit receives project scale (e.g., budget amount, number of participants, duration as numerical vectors) and industry (e.g., IT, construction, manufacturing, marketing as category labels) as input. The learning unit automatically selects the optimal model from multiple learning algorithms (e.g., for large-scale projects: deep neural networks; for IT industry: Transformer-based; for construction industry: rule-based+decision tree; for manufacturing: time-series analysis+clustering) based on the input scale and industry information. Examples of input to the AI include “Scale: Budget 100 million yen, 50 people, 12 months, Industry: IT” and “Scale: Budget 5 million yen, 5 people, 2 months, Industry: Construction.” Examples of AI output include “Applied model: Deep NN+Transformer, Output: Detailed plan template with technical requirements” and “Applied model: Decision tree+rule-based, Output: Concise plan template focused on schedule management.” After model selection, the learning unit learns from past plan data using the relevant algorithm and performs feature extraction and template generation. Internal processing of the AI model utilizes meta-learning methods (e.g., model selection networks) and ensemble learning (e.g., weighted averaging of multiple models) to achieve optimization according to project attributes. In subsequent processing, the extraction unit and generation unit refer to this optimized template and automatically reflect it when creating plans. As a technical effect, the learning unit greatly improves plan suitability, quality, and creation efficiency by flexible model selection and optimization according to the characteristics of each project, which is different from conventional uniform algorithm application. Applicable fields include IT system development, construction, manufacturing, marketing, and other project-based operations with high diversity in scale and industry. Furthermore, variations of the AI model include dynamic model switching according to attribute changes during project progress and cross-industry hybrid learning. Thus, the learning unit achieves not only automation but also technical improvement and enhanced flexibility of the plan creation process.

The learning unit can estimate a user's emotion and adjust the frequency of learning based on the estimated emotion of the user. For example, the learning unit estimates a user's emotion and adjusts the frequency of learning based on the estimated emotion. The learning unit uses a generative AI to estimate a user's emotion. The generative AI, for example, uses an emotion estimation algorithm to estimate a user's emotion. The generative AI analyzes data such as the user's facial expressions, voice, and text to calculate an emotion score. For example, if the user is feeling stressed, the frequency of learning is reduced and more time for relaxation is provided. If the user is focused, the frequency of learning is increased for efficient learning. If the user is tired, the frequency of learning is adjusted and breaks are inserted during learning. By adjusting the frequency of learning based on the user's emotion, a learning pace suitable for the user can be provided. Emotion estimation is realized, for example, by using an emotion engine or a generative AI with emotion estimation functionality. The generative AI may be a text generation AI (such as an LLM) or a multimodal generative AI, but is not limited to these examples. Some or all of the above-described processing in the learning unit may be performed using AI or may be performed without using AI. For example, the learning unit may use an AI model that estimates a user's emotion to estimate the user's emotion and adjust the frequency of learning. Specifically, the learning unit receives multimodal input data for emotion estimation (e.g., RGB tensor of facial images (224×224×3), time-series array of voice waveform, token sequence of text chat) and applies a convolutional neural network (CNN) to facial images, spectrogram+recurrent neural network (RNN) to voice, and Transformer encoder to text to extract feature vectors. The learning unit integrates these feature vectors and calculates emotion scores (e.g., stress level 0.75, concentration level 0.85, fatigue level 0.60). Examples of input to the AI include “Facial image: tense expression, Voice: sighing, Text: ‘I'm tired today’” and “Facial image: serious expression, Voice: clear speech, Text: ‘I want to learn more.’” Examples of AI output include emotion score vectors such as “Stress level 0.80, concentration level 0.20, fatigue level 0.70” and “Stress level 0.10, concentration level 0.90, fatigue level 0.10.” Based on the emotion scores, the learning frequency control module executes rule-based control such as “If stress level>0.7, reduce learning frequency by half; if concentration level>0.8, increase learning frequency by 1.5 times; if fatigue level>0.6, insert a 5-minute break between learning sessions.” Internal processing of the AI model for emotion estimation uses cross-entropy loss or MSE loss for learning and combines supervised learning and self-supervised learning. In subsequent processing, the learning frequency adjustment results are reflected in the user interface to present the optimal learning pace to the user. As a technical effect, the learning unit maximizes learning efficiency, reduces user stress, and improves learning continuation rate by dynamically optimizing learning frequency according to the user's real-time emotional state, which is different from conventional uniform learning frequency settings. Applicable fields include e-learning, corporate training, medical education, school education, and other education fields where individual optimization is required. Furthermore, variations of emotion estimation AI include estimation using only facial images, only voice, only text, or multimodal estimation combining these, and the configuration can be flexibly changed according to the usage environment and privacy requirements. Thus, the learning unit achieves not only automation but also technical improvement of the learning process and qualitative improvement of user experience.

The learning unit can weight learning data based on the progress of the project during learning. For example, the learning unit weights learning data based on the progress of the project during learning. The learning unit uses a generative AI to weight learning data based on the progress of the project. The generative AI, for example, uses a text generation AI (such as an LLM) to weight learning data based on the progress of the project. The generative AI assigns higher weights to learning data related to planning in the initial stage of the project. For example, in the middle stage of the project, higher weights are assigned to learning data related to resource management. In the final stage of the project, higher weights are assigned to learning data related to quality management of deliverables. By weighting learning data based on the progress of the project, appropriate learning data can be provided. Some or all of the above-described processing in the learning unit may be performed using AI or may be performed without using AI. For example, the learning unit may use an AI model that weights learning data based on the progress of the project to weight learning data based on the progress of the project. Specifically, the learning unit receives time-series data indicating the progress of the project (e.g., progress rate 0-1, current phase (planning, design, implementation, testing, delivery), remaining days, achieved milestones as numerical and categorical data) as input. The learning unit vectorizes the progress data using a time-series encoder (e.g., LSTM, Transformer Encoder) and calculates weight scores (e.g., 0.8, 0.5, 0.2) for each category in the learning database (e.g., planning, resource management, quality management). Examples of input to the AI include “Progress rate 0.1, Phase: Planning,” “Progress rate 0.5, Phase: Implementation,” and “Progress rate 0.9, Phase: Quality Management.” Examples of AI output include weight vectors such as “Weight: Planning 0.9, Resource Management 0.3, Quality Management 0.1,” “Weight: Planning 0.2, Resource Management 0.8, Quality Management 0.4,” and “Weight: Planning 0.1, Resource Management 0.2, Quality Management 0.9.” The learning unit uses these weight scores to preferentially extract data of the relevant category from the learning database and present it to the user. Internal processing of the AI model for weighting uses attention mechanisms and weight optimization algorithms (e.g., softmax normalization) to provide optimal learning data according to project progress. In subsequent processing, the extraction unit and generation unit refer to this weighting information and automatically reflect it when creating plans. As a technical effect, the learning unit achieves efficiency in plan creation, improvement of quality, and maximization of learning outcomes by dynamically selecting and presenting optimal learning data according to project progress, which is different from conventional uniform learning data presentation. Applicable fields include IT system development, construction, manufacturing, research and development, and other project-based operations where knowledge updating according to progress is required. Furthermore, variations of the AI model include anomaly detection for progress and automatic emphasis of key learning data in case of progress delays. Thus, the learning unit achieves not only automation but also technical improvement of the plan creation process and optimization of knowledge transfer.

The learning unit can select learning data in consideration of the geographical distribution of the project during learning. For example, the learning unit selects learning data in consideration of the geographical distribution of the project during learning. The learning unit uses a generative AI to select learning data in consideration of the geographical distribution of the project. The generative AI, for example, uses a text generation AI (such as an LLM) to select learning data in consideration of the geographical distribution of the project. The generative AI preferentially learns data from geographically close projects. For example, the learning unit compares project data from different regions and learns commonalities. The learning unit learns risk management methods according to geographical conditions. By selecting learning data in consideration of the geographical distribution of the project, region-specific requirements can be addressed. Some or all of the above-described processing in the learning unit may be performed using AI or may be performed without using AI. For example, the learning unit may use an AI model that selects learning data in consideration of the geographical distribution of the project to select learning data in consideration of the geographical distribution of the project. Specifically, the learning unit receives geographical distribution information of the project (e.g., latitude and longitude coordinates, prefecture/city name, climate classification, disaster risk index as structured data) as input. The learning unit filters project data in the learning database using spatial neighbor search algorithms (e.g., k-nearest neighbor, spatial clustering) based on geographical attributes and preferentially extracts data from geographically close projects. Examples of input to the AI include “Geographical information: Chiyoda-ku, Tokyo, Climate: temperate, Disaster risk: low” and “Geographical information: Sapporo, Hokkaido, Climate: cold, Disaster risk: medium.” Examples of AI output include project lists such as “Selected data: 10 past project plans in Tokyo” and “Selected data: 5 past project plans in Hokkaido.” The learning unit compares project data from different regions, extracts commonalities and region-specific risk management methods (e.g., earthquake countermeasures, heavy snow countermeasures, flood countermeasures), and templates them. Internal processing of the AI model uses encoding of geographical attributes (e.g., coordinate embedding, category embedding) and spatial similarity calculation to select learning data according to regional characteristics. In subsequent processing, the extraction unit and generation unit refer to this region-specific template and automatically reflect it when creating plans. As a technical effect, the learning unit achieves rapid response to region-specific requirements, advanced risk management, and improvement of plan quality by optimal selection of learning data according to geographical distribution, which is different from conventional uniform learning data presentation. Applicable fields include IT system development, construction, manufacturing, infrastructure development, and other project-based operations where regional characteristics are important. Furthermore, variations of the AI model include multivariate optimization considering geographical distribution, climate, disaster risk, legal regulations, and other factors simultaneously. Thus, the learning unit achieves not only automation but also technical improvement of the plan creation process and enhancement of regional adaptability.

The extraction unit can estimate a user's emotion and determine the priority of content to be extracted based on the estimated emotion of the user. For example, the extraction unit estimates a user's emotion and determines the priority of content to be extracted based on the estimated emotion. The extraction unit uses a generative AI to estimate a user's emotion. The generative AI, for example, uses an emotion estimation algorithm to estimate a user's emotion. The generative AI analyzes data such as the user's facial expressions, voice, and text to calculate an emotion score. For example, if the user is feeling stressed, important content is preferentially extracted. If the user is focused, detailed content is preferentially extracted. If the user is tired, concise content is preferentially extracted. By determining the priority of content based on the user's emotion, content suitable for the user can be provided. Emotion estimation is realized, for example, by using an emotion engine or a generative AI with emotion estimation functionality. The generative AI may be a text generation AI (such as an LLM) or a multimodal generative AI, but is not limited to these examples. Some or all of the above-described processing in the extraction unit may be performed using AI or may be performed without using AI. For example, the extraction unit may use an AI model that estimates a user's emotion to estimate the user's emotion and determine the priority of content to be extracted. Specifically, the extraction unit simultaneously receives multimodal input data for emotion estimation (e.g., RGB tensor of facial images (224×224×3), time-series array of voice waveform (sampling rate 16 kHz, length 2 seconds), token sequence of chat text (up to 512 tokens)). For facial images, the extraction unit uses a convolutional neural network (CNN) to extract facial features (e.g., eye opening/closing, mouth corner movement, eyebrow shape), for voice data, it extracts prosodic features (e.g., pitch, speech rate, intonation) using spectrogram conversion followed by a recurrent neural network (RNN) or Transformer encoder, and for text data, it generates context feature vectors using a pre-trained large language model (e.g., multi-layer Transformer encoder). The extraction unit integrates these feature vectors with a multilayer perceptron (MLP) and finally outputs an “emotion score” (e.g., stress level 0.85, concentration level 0.60, fatigue level 0.30, as continuous values from 0 to 1). Examples of input to the AI include “Facial image: serious expression, Voice: clear speech, Text: ‘I want to read detailed materials.’” and “Facial image: tired expression, Voice: sighing, Text: ‘I'm tired today.’” Examples of AI output include emotion score vectors such as “Stress level 0.80, concentration level 0.20, fatigue level 0.70” and “Stress level 0.10, concentration level 0.90, fatigue level 0.10.” The extraction unit uses these emotion scores for threshold judgment (e.g., if stress level>0.7, prioritize important content; if concentration level>0.8, prioritize detailed content; if fatigue level>0.6, prioritize concise content) and determines the priority of content to be extracted. The content to be extracted is managed as tagged structured data (e.g., sections with importance labels, explanatory text with detail scores, summary of key points), and the extraction unit dynamically adjusts the extraction order and content according to priority. Internal processing of the AI model for emotion estimation uses cross-entropy loss or MSE loss functions and can combine supervised learning (e.g., emotion-labeled datasets) and self-supervised learning (e.g., multimodal contrastive learning). In subsequent processing, the prioritized extracted content is passed to the addition unit or generation unit and reflected in the draft generation of the plan. As a technical effect, the extraction unit maximizes learning efficiency and improves user satisfaction by preferentially presenting optimal information according to the user's real-time emotional state, which is different from conventional uniform content extraction. Applicable fields include e-learning for IT engineers, corporate training, medical professional education, school education, and other education and training fields where individual optimization is required. Furthermore, variations of emotion estimation AI include estimation using only facial images, only voice, only text, or multimodal estimation combining these, and the configuration can be flexibly changed according to the usage environment and privacy requirements. Thus, the extraction unit achieves not only automation but also technical improvement of the information extraction process and qualitative improvement of user experience.

The extraction unit can analyze the frequency of common portions in past plans during extraction and preferentially extract portions with high frequency. For example, the extraction unit analyzes the frequency of common portions in past plans during extraction and preferentially extracts portions with high frequency. The extraction unit uses a generative AI to analyze the frequency of common portions in past plans. The generative AI, for example, uses a text generation AI (such as an LLM) to analyze the frequency of common portions in past plans. The generative AI preferentially extracts project objectives with high frequency. For example, the extraction unit preferentially extracts schedule management methods with high frequency. The extraction unit preferentially extracts resource allocation methods with high frequency. By preferentially extracting portions with high frequency, standardized content can be efficiently extracted. Some or all of the above-described processing in the extraction unit may be performed using AI or may be performed without using AI. For example, the extraction unit may use an AI model that analyzes the frequency of common portions in past plans to analyze the frequency of common portions and preferentially extract portions with high frequency. Specifically, the extraction unit receives past project plan data (e.g., text files, PDFs, structured databases) as input. The extraction unit performs preprocessing to convert these data into token sequences or context vectors for natural language processing (e.g., 768-dimensional vectors by Transformer encoders) and extracts features such as “project objective,” “schedule,” and “resource allocation” for each section of the plan. The extraction unit uses frequency analysis algorithms (e.g., word/phrase occurrence frequency count, TF-IDF, n-gram analysis) or clustering methods (e.g., K-means clustering, principal component analysis) to automatically extract elements that commonly appear across multiple plans. Examples of input to the AI include “Section lists of plans from 2020 to 2023” and “tagged text data.” Examples of AI output include frequency-attached structured data such as “Top frequency: Project Objective=New Introduction (80%), Schedule=6 months (65%), Resource Allocation=Standard Configuration (70%).” The extraction unit stores reusable common portions in the template database based on frequency scores and enables rapid reuse in subsequent plan creation. Internal processing of the AI model includes normalization of frequency distribution and threshold setting (e.g., portions with occurrence rate of 50% or more are regarded as common portions), and rule-based processing to exclude noise and outliers. In subsequent processing, the extracted common portions are passed to the addition unit or generation unit and reflected in the draft generation of the plan. As a technical effect, the extraction unit achieves reduction of creation time, reduction of omissions, and homogenization of plan quality by automatic extraction in a high-dimensional feature space, which is different from manual copy-paste or rule-based processing. Applicable fields include IT system development, construction, manufacturing, research and development, and other industries where efficiency through templating is required. Furthermore, variations of frequency analysis AI include trend analysis of time-series changes and comparison of frequency distribution by industry or scale. Thus, the extraction unit achieves not only automation but also technical improvement of the information extraction process and improvement of template quality.

The extraction unit can apply different extraction algorithms for each project category during extraction. For example, the extraction unit applies different extraction algorithms for each project category during extraction. The extraction unit uses a generative AI to apply different extraction algorithms for each project category. The generative AI, for example, uses a text generation AI (such as an LLM) to apply different extraction algorithms for each project category. The generative AI applies extraction algorithms for IT projects to preferentially extract technical requirements. For example, extraction algorithms for construction projects are applied to preferentially extract schedule management. Extraction algorithms for marketing projects are applied to preferentially extract market analysis. By applying different extraction algorithms for each project category, appropriate content can be extracted. Some or all of the above-described processing in the extraction unit may be performed using AI or may be performed without using AI. For example, the extraction unit may use an AI model that applies different extraction algorithms for each project category to apply different extraction algorithms for each project category. Specifically, the extraction unit receives project category information (e.g., category labels such as IT, construction, manufacturing, marketing) as input. The extraction unit automatically selects optimized extraction algorithms for each category (e.g., for IT: Transformer-based technical requirement extraction; for construction: rule-based+decision tree schedule management extraction; for marketing: natural language processing+clustering market analysis extraction) and extracts features of the relevant category from past plan data. Examples of input to the AI include “Category: IT, plan data: full text” and “Category: Construction, plan data: full text.” Examples of AI output include category-specific structured data such as “IT extraction result: Technical requirements=Cloud integration required, API design details” and “Construction extraction result: Schedule management=12 months, with process chart.” The extraction unit switches extraction rules and feature sets for each category to extract industry-specific requirements and management items without omission. Internal processing of the AI model utilizes meta-learning methods (e.g., category judgment networks) and ensemble learning (e.g., weighted averaging of multiple extraction models) to achieve optimization according to project attributes. In subsequent processing, the extracted category-specific content is passed to the addition unit or generation unit and reflected in the draft generation of the plan. As a technical effect, the extraction unit greatly improves plan suitability, quality, and creation efficiency by flexible model selection and optimization according to the characteristics of each project, which is different from conventional uniform extraction algorithm application. Applicable fields include IT system development, construction, manufacturing, marketing, and other project-based operations with high diversity in categories. Furthermore, variations of extraction algorithms include cross-category hybrid extraction and dynamic model switching according to category attribute changes. Thus, the extraction unit achieves not only automation but also technical improvement of the information extraction process and enhanced flexibility.

The extraction unit can estimate a user's emotion and adjust the display method of content to be extracted based on the estimated emotion of the user. For example, the extraction unit estimates a user's emotion and adjusts the display method of content to be extracted based on the estimated emotion. The extraction unit uses a generative AI to estimate a user's emotion. The generative AI, for example, uses an emotion estimation algorithm to estimate a user's emotion. The generative AI analyzes data such as the user's facial expressions, voice, and text to calculate an emotion score. For example, if the user is nervous, a simple and highly visible display method is provided. If the user is relaxed, a display method including detailed information is provided. If the user is in a hurry, a display method focusing on key points is provided. By adjusting the display method of content based on the user's emotion, a display method suitable for the user can be provided. Emotion estimation is realized, for example, by using an emotion engine or a generative AI with emotion estimation functionality. The generative AI may be a text generation AI (such as an LLM) or a multimodal generative AI, but is not limited to these examples. Some or all of the above-described processing in the extraction unit may be performed using AI or may be performed without using AI. For example, the extraction unit may use an AI model that estimates a user's emotion to estimate the user's emotion and adjust the display method of content to be extracted. Specifically, the extraction unit receives multimodal input data for emotion estimation (e.g., RGB tensor of facial images, time-series array of voice waveform, token sequence of chat text) and applies a convolutional neural network (CNN) to facial images, spectrogram+recurrent neural network (RNN) to voice, and Transformer encoder to text to extract feature vectors. The extraction unit integrates these feature vectors and calculates emotion scores (e.g., nervousness level 0.80, relaxation level 0.60, urgency level 0.90). Examples of input to the AI include “Facial image: tense expression, Voice: fast speech, Text: ‘I'm in a hurry’” and “Facial image: calm expression, Voice: slow speech, Text: ‘I want to read carefully.’” Examples of AI output include emotion score vectors such as “Nervousness level 0.85, relaxation level 0.10, urgency level 0.90” and “Nervousness level 0.10, relaxation level 0.90, urgency level 0.10.” Based on the emotion scores, the display control module executes rule-based control such as “If nervousness level>0.7, simple display; if relaxation level>0.7, detailed display; if urgency level>0.7, key point display.” Multiple display formats (e.g., text summary, diagrams, bullet points, detailed explanations) are prepared for extracted content, and the optimal display method is automatically selected according to the user's emotional state. Internal processing of the AI model for emotion estimation uses cross-entropy loss or MSE loss for learning and combines supervised learning and self-supervised learning. In subsequent processing, the display method is reflected in the user interface to optimize the user experience. As a technical effect, the extraction unit improves information comprehension, reduces stress, and increases learning continuation rate by dynamically optimizing the display method according to the user's real-time emotional state, which is different from conventional uniform display methods. Applicable fields include e-learning, corporate training, medical education, school education, and other education fields where individual optimization is required. Furthermore, variations of emotion estimation AI include estimation using only facial images, only voice, only text, or multimodal estimation combining these, and the configuration can be flexibly changed according to the usage environment and privacy requirements. Thus, the extraction unit achieves not only automation but also technical improvement of the information presentation process and qualitative improvement of user experience.

The extraction unit can determine the priority of extraction based on the submission timing of the project during extraction. For example, the extraction unit determines the priority of extraction based on the submission timing of the project during extraction. The extraction unit uses a generative AI to determine the priority of extraction based on the submission timing of the project. The generative AI, for example, uses a text generation AI (such as an LLM) to determine the priority of extraction based on the submission timing of the project. The generative AI preferentially extracts content for projects with imminent submission deadlines. For example, content for projects with distant submission deadlines is postponed. The detail level of content to be extracted is adjusted according to the submission deadline. By determining the priority of extraction based on the submission timing of the project, content suitable for the submission deadline can be provided. Some or all of the above-described processing in the extraction unit may be performed using AI or may be performed without using AI. For example, the extraction unit may use an AI model that determines the priority of extraction based on the submission timing of the project to determine the priority of extraction based on the submission timing of the project. Specifically, the extraction unit receives submission timing information of the project (e.g., submission deadline date, remaining days, priority label as structured data) as input. The extraction unit calculates a priority score based on the submission timing data (e.g., the fewer remaining days, the higher the score) and dynamically adjusts the extraction order and detail level of content to be extracted. Examples of input to the AI include “Submission deadline: 2024-07-01, Remaining days: 3” and “Submission deadline: 2024-08-15, Remaining days: 30.” Examples of AI output include extraction instruction data with priority such as “Priority: High, Detail level: Key points only” and “Priority: Low, Detail level: With detailed explanation.” The extraction unit preferentially extracts concise content focused on key points when the submission deadline is near, and extracts detailed explanations and supplementary information when there is sufficient time before the deadline. Internal processing of the AI model includes mapping rules between submission timing and priority, and scheduling algorithms (e.g., priority queue, Gantt chart integration) to optimize extraction order. In subsequent processing, the prioritized extracted content is passed to the addition unit or generation unit and reflected in the draft generation of the plan. As a technical effect, the extraction unit improves on-time delivery rate, work efficiency, and homogenization of plan quality by flexible information extraction according to submission timing, which is different from conventional uniform extraction order and detail level settings. Applicable fields include IT system development, construction, manufacturing, research and development, and other project-based operations where deadline management is important. Furthermore, variations of submission timing-linked AI include automatic reminders in case of progress delays and priority optimization across multiple projects. Thus, the extraction unit achieves not only automation but also technical improvement of the information extraction process and advanced deadline management.

The extraction unit can refer to related literature of the project during extraction to improve extraction accuracy. For example, the extraction unit refers to related literature of the project during extraction to improve extraction accuracy. The extraction unit uses a generative AI to refer to related literature of the project. The generative AI, for example, uses a text generation AI (such as an LLM) to refer to related literature of the project. The generative AI confirms the accuracy of content to be extracted based on related literature. For example, the extraction unit refers to related literature to improve the reliability of content to be extracted. The extraction unit utilizes related literature to enhance the comprehensiveness of content to be extracted. By referring to related literature of the project during extraction, accurate content can be provided. Some or all of the above-described processing in the extraction unit may be performed using AI or may be performed without using AI. For example, the extraction unit may use an AI model that refers to related literature of the project to refer to related literature and improve extraction accuracy. Specifically, the extraction unit receives related literature data of the project (e.g., paper PDFs, technical articles, standard specifications, patent documents as text data) as input. The extraction unit converts these into token sequences or context vectors for natural language processing (e.g., 768-dimensional vectors by Transformer encoders) and calculates semantic similarity between the plan text or candidate content for extraction and the related literature. Examples of input to the AI include “Plan section: Risk management, Related literature: Full text of ISO31000” and “Plan section: Technical requirements, Related literature: Latest technical article.” Examples of AI output include candidate extraction lists with reliability such as “Candidate: Risk management method A (similarity 0.92), method B (similarity 0.85)” and “Candidate: Technical requirement X (reliability 0.95), requirement Y (reliability 0.88).” The extraction unit automatically evaluates the accuracy and comprehensiveness of extracted content based on similarity and reliability scores with related literature, and extracts only candidates above the threshold. Internal processing of the AI model combines semantic similarity calculation (e.g., cosine similarity, distance between BERT embedding vectors) and reliability estimation algorithms (e.g., supervised learning for accuracy prediction). In subsequent processing, the high-accuracy extracted content is passed to the addition unit or generation unit and reflected in the draft generation of the plan. As a technical effect, the extraction unit greatly improves extraction accuracy, comprehensiveness, and reliability by automatic evaluation and selection in a high-dimensional feature space by AI, which is different from manual literature reference or extraction based on experience. Applicable fields include IT system development, construction, manufacturing, research and development, and other project-based operations where reference to technical standards and best practices is important. Furthermore, variations of literature reference AI include time-series tracking of literature updates and cross-lingual extraction for multiple languages. Thus, the extraction unit achieves not only automation but also technical improvement of the information extraction process and advanced utilization of knowledge.

The addition unit can estimate a user's emotion and adjust the expression method of content to be added based on the estimated emotion of the user. For example, the addition unit estimates the user's emotion and adjusts the expression method of the content to be added according to the estimated emotion. The addition unit uses a generative AI to estimate the user's emotion. The generative AI, for example, uses an emotion estimation algorithm to estimate the user's emotion. The generative AI analyzes data such as the user's facial expressions, voice, and text to calculate an emotion score. For example, if the user is feeling stressed, a concise and easy-to-understand expression method is adopted. If the user is focused, an expression method including detailed technical information is adopted. If the user is tired, a visually easy-to-read expression method is adopted. By adjusting the expression method of content based on the user's emotion, it is possible to provide an expression method suitable for the user. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the addition unit may be performed using AI, or may be performed without using AI. For example, the addition unit may use an AI model for estimating the user's emotion to estimate the user's emotion and adjust the expression method of the content to be added. Specifically, the addition unit simultaneously receives multimodal input data for user emotion estimation (e.g., RGB tensor of facial image (224×224×3), time-series array of voice waveform (sampling rate 16 kHz, length 2 seconds), token sequence of chat text (up to 512 tokens)). The addition unit extracts facial features (e.g., eye opening/closing, movement of mouth corners, shape of eyebrows, etc.) from facial images using a convolutional neural network, extracts prosodic features (e.g., pitch, speech rate, intonation) from voice data after spectrogram conversion using a recurrent neural network or Transformer encoder, and generates contextual feature vectors from text data using a pre-trained large language model. The addition unit integrates these feature vectors with a multilayer perceptron and finally outputs an “emotion score” (e.g., stress level 0.85, concentration level 0.60, fatigue level 0.30, etc., as continuous values from 0 to 1). Examples of AI input include “Facial image: tense expression, voice: sighing, text: ‘I'm tired today’” and “Facial image: serious expression, voice: clear speech, text: ‘I want to learn more’”. Examples of AI output include emotion score vectors such as “stress level 0.80, concentration level 0.20, fatigue level 0.70” and “stress level 0.10, concentration level 0.90, fatigue level 0.10”. Based on the emotion score, the expression control module executes rule-based control such as “if stress level>0.7, use concise expression; if concentration level>0.8, add detailed technical information; if fatigue level>0.6, use visually oriented expression with diagrams and icons”. Multiple expression formats (e.g., text summary, detailed explanation, diagram, bullet points, infographic, etc.) are prepared for the additional content, and the optimal expression method is automatically selected according to the user's emotional state. Internally, the AI model uses cross-entropy loss or MSE loss for training the emotion estimation unit, combining supervised and self-supervised learning. In subsequent processing, the expression method is reflected when generating additional content and passed to the generation unit. As a technical effect, the addition unit dynamically optimizes the expression method according to the user's real-time emotional state, unlike conventional uniform expression methods, thereby improving information comprehension, reducing stress, and increasing learning continuation rates. Application fields include e-learning, corporate training, medical education, school education, and other educational fields where individual optimization is required. Furthermore, variations of emotion estimation AI include estimation using only facial images, only voice, only text, or multimodal estimation combining these, allowing flexible configuration according to usage environment and privacy requirements. Thus, the addition unit goes beyond mere automation to achieve technical improvement of the information presentation process and qualitative enhancement of user experience.

The addition unit can analyze the customer's past requirement history at the time of addition and select an appropriate addition method. For example, the addition unit analyzes the customer's past requirement history at the time of addition and selects an appropriate addition method. The addition unit uses generative AI to analyze the customer's past requirement history. The generative AI, for example, uses a text generative AI (e.g., LLM) to analyze the customer's past requirement history. Based on the customer's past requirement history, the generative AI adds optimal content. For example, content that is frequently requested in the customer's requirement history is preferentially added. The customer's requirement history is analyzed, and content corresponding to specific requirements is added. By analyzing the customer's past requirement history, optimal content can be added. Some or all of the above-described processing in the addition unit may be performed using AI, or may be performed without using AI. For example, the addition unit may use an AI model for analyzing the customer's past requirement history to analyze the customer's past requirement history and select an appropriate addition method. Specifically, the addition unit receives requirement history data for each customer (e.g., list of the last 10 requirements, requirement text, date of requirement, requirement category, response history, etc., as structured data) as input. The addition unit vectorizes requirement text using natural language processing algorithms (e.g., Transformer encoder, BERT, etc.), extracts requirement patterns using frequency analysis algorithms (e.g., TF-IDF, n-gram analysis) and clustering methods (e.g., K-means clustering). The addition unit lists frequent requirements and highly rated requirements with priority scores and generates candidate content for addition. Examples of AI input include “Requirement history: cloud integration, security enhancement, API extension” and “Requirement history: UI improvement, faster response”. Examples of AI output include prioritized structured data such as “Addition candidate: cloud integration function (priority 0.9), security enhancement (priority 0.8)” and “Addition candidate: UI improvement (priority 0.7), faster response (priority 0.6)”. Based on the requirement history analysis results, the addition unit automatically selects the addition method (e.g., automatic merging into template, insertion into requirement section, custom section generation, etc.) and reflects it in the project plan draft. Internally, the AI model can also combine time-series analysis of requirement history and correlation analysis between requirement content and project outcomes (e.g., relationship between requirement reflection rate and customer satisfaction). In subsequent processing, the added content is passed to the generation unit and reflected when generating the project plan draft. As a technical effect, the addition unit, unlike conventional manual requirement management and subjective judgment, achieves optimal content addition for each customer, improved requirement reflection rate, and homogenization of plan quality through AI-based history analysis and automatic prioritization. Application fields include IT system development, contract development, custom product design in manufacturing, customer response history management in service industries, and other industries where requirement history utilization is important. Furthermore, variations of the AI model can realize time-series trend analysis of requirement history and comparison of requirement similarity among multiple customers. Thus, the addition unit goes beyond mere automation to achieve technical improvement of the requirement management process and enhancement of customer satisfaction.

The addition unit can apply different addition algorithms according to the customer's industry and scale at the time of addition. For example, the addition unit applies different addition algorithms according to the customer's industry and scale at the time of addition. The addition unit uses generative AI to apply different addition algorithms according to the customer's industry and scale. The generative AI, for example, uses a text generative AI (e.g., LLM) to apply different addition algorithms according to the customer's industry and scale. The generative AI applies addition algorithms for large-scale customers and adds detailed content. For example, addition algorithms for small-scale customers are applied to add concise content. Industry-specific addition algorithms are applied to add content reflecting industry-specific requirements. By applying addition algorithms according to the customer's industry and scale, appropriate content can be added. Some or all of the above-described processing in the addition unit may be performed using AI, or may be performed without using AI. For example, the addition unit may use an AI model for applying different addition algorithms according to the customer's industry and scale to apply different addition algorithms according to the customer's industry and scale. Specifically, the addition unit receives the customer's industry (e.g., IT, construction, manufacturing, marketing, etc., as category labels) and scale (e.g., number of employees, sales, project budget, etc., as numerical vectors) as input. Based on the input industry and scale information, the addition unit automatically selects the optimal model from multiple addition algorithms (e.g., for large-scale customers: deep neural network+detailed requirement extraction; for small-scale customers: rule-based+key point extraction; industry-specific: industry-specific template matching, etc.). Examples of AI input include “Industry: IT, scale: 500 employees, budget: 100 million yen” and “Industry: construction, scale: 10 employees, budget: 10 million yen”. Examples of AI output include “Applied model: deep NN+detailed requirement addition, output: detailed technical specifications” and “Applied model: rule-based+key point extraction, output: concise construction period management”. After model selection, the addition unit generates additional content using the corresponding algorithm and reflects the optimal information according to industry and scale in the project plan draft. Internally, the AI model utilizes meta-learning methods (e.g., model selection network) and ensemble learning (e.g., weighted average of multiple models) to achieve optimization according to customer attributes. In subsequent processing, the added content is passed to the generation unit and reflected when generating the project plan draft. As a technical effect, the addition unit, unlike conventional uniform algorithm application, greatly improves the suitability, quality, and creation efficiency of the plan by flexible model selection and optimization according to each customer's characteristics. Application fields include IT system development, construction, manufacturing, marketing, and other project-based operations with high diversity in industry and scale. Furthermore, variations of the AI model can realize dynamic model switching according to attribute changes during project progress and hybrid addition across multiple industries. Thus, the addition unit goes beyond mere automation to achieve technical improvement and enhanced flexibility in the information addition process.

The addition unit can estimate a user's emotion and determine the priority of content to be added based on the estimated emotion of the user. For example, the addition unit estimates the user's emotion and determines the priority of content to be added according to the estimated emotion. The addition unit uses generative AI to estimate the user's emotion. The generative AI, for example, uses an emotion estimation algorithm to estimate the user's emotion. The generative AI analyzes data such as the user's facial expressions, voice, and text to calculate an emotion score. For example, if the user is feeling stressed, important content is preferentially added. If the user is focused, detailed content is preferentially added. If the user is tired, concise content is preferentially added. By determining the priority of content to be added based on the user's emotion, content suitable for the user can be provided. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the addition unit may be performed using AI, or may be performed without using AI. For example, the addition unit may use an AI model for estimating the user's emotion to estimate the user's emotion and determine the priority of content to be added. Specifically, the addition unit receives multimodal input data for user emotion estimation (e.g., RGB tensor of facial image, time-series array of voice waveform, token sequence of chat text) and applies a convolutional neural network to facial images, spectrogram+recurrent neural network to voice, and Transformer encoder to text to extract feature vectors. The addition unit integrates these feature vectors and calculates emotion scores (e.g., stress level 0.75, concentration level 0.85, fatigue level 0.60, etc.). Examples of AI input include “Facial image: tense expression, voice: sighing, text: ‘I'm tired today’” and “Facial image: serious expression, voice: clear speech, text: ‘I want to learn more’”. Examples of AI output include emotion score vectors such as “stress level 0.80, concentration level 0.20, fatigue level 0.70” and “stress level 0.10, concentration level 0.90, fatigue level 0.10”. Based on the emotion score, the priority control module executes rule-based control such as “if stress level>0.7, prioritize important content; if concentration level>0.8, prioritize detailed content; if fatigue level>0.6, prioritize concise content”. Candidate content for addition is managed as tagged structured data (e.g., sections with importance labels, explanations with detail scores, key point summaries, etc.), and the addition unit dynamically adjusts the order and content according to priority. Internally, the AI model uses cross-entropy loss or MSE loss for training the emotion estimation unit, combining supervised and self-supervised learning. In subsequent processing, prioritized additional content is passed to the generation unit and reflected when generating the project plan draft. As a technical effect, the addition unit, unlike conventional uniform content addition, preferentially adds optimal information according to the user's real-time emotional state, thereby reducing stress from information overload, maximizing learning efficiency, and improving user satisfaction. Application fields include e-learning for IT engineers, in-house training, medical professional education, school education, and other educational and training fields where individual optimization is required. Furthermore, variations of emotion estimation AI include estimation using only facial images, only voice, only text, or multimodal estimation combining these, allowing flexible configuration according to usage environment and privacy requirements. Thus, the addition unit goes beyond mere automation to achieve technical improvement of the information addition process and qualitative enhancement of user experience.

The addition unit can preferentially add highly relevant content by considering the customer's geographic location information at the time of addition. For example, the addition unit preferentially adds highly relevant content by considering the customer's geographic location information at the time of addition. The addition unit uses generative AI to consider the customer's geographic location information. The generative AI, for example, uses a text generative AI (e.g., LLM) to consider the customer's geographic location information. Based on the customer's geographic location information, the generative AI adds highly relevant content. For example, content is added by referring to the requirements of geographically close customers. Methods of risk management according to geographic conditions are added. By considering the customer's geographic location information, highly relevant content can be provided. Some or all of the above-described processing in the addition unit may be performed using AI, or may be performed without using AI. For example, the addition unit may use an AI model for considering the customer's geographic location information to preferentially add highly relevant content by considering the customer's geographic location information. Specifically, the addition unit receives the customer's geographic location information (e.g., latitude and longitude coordinates, prefecture/city name, climate classification, disaster risk index, etc., as structured data) as input. Based on geographic attributes, the addition unit filters project data in the candidate content database using spatial neighborhood search algorithms (e.g., k-nearest neighbors, spatial clustering) and preferentially extracts requirements and past cases of geographically close customers. Examples of AI input include “Geographic information: Chiyoda-ku, Tokyo, climate: temperate, disaster risk: low” and “Geographic information: Sapporo, Hokkaido, climate: cold, disaster risk: medium”. Examples of AI output include project lists such as “Addition candidate: content reflecting the last 10 requirements in Tokyo” and “Addition candidate: risk management methods from the last 5 cases in Hokkaido”. The addition unit compares project data from different regions, extracts common points and region-specific risk management methods (e.g., earthquake countermeasures, heavy snow countermeasures, flood countermeasures, etc.), and templates them. Internally, the AI model uses geographic attribute encoding (e.g., coordinate embedding, category embedding) and spatial similarity calculation to select additional content according to regional characteristics. In subsequent processing, the extracted region-specific content is passed to the generation unit and reflected when generating the project plan draft. As a technical effect, the addition unit, unlike conventional uniform content addition, achieves rapid response to region-specific requirements, advanced risk management, and improved plan quality by optimal selection of additional content according to geographic distribution. Application fields include IT system development, construction, manufacturing, infrastructure development, and other project-based operations where regional characteristics are important. Furthermore, variations of the AI model can realize multivariate optimization considering geographic distribution, climate, disaster risk, legal regulations, and other factors simultaneously. Thus, the addition unit goes beyond mere automation to achieve technical improvement of the information addition process and enhancement of regional adaptability.

The addition unit can analyze the customer's social media activity at the time of addition and add related content. For example, the addition unit analyzes the customer's social media activity at the time of addition and adds related content. The addition unit uses generative AI to analyze the customer's social media activity. The generative AI, for example, uses a text generative AI (e.g., LLM) to analyze the customer's social media activity. Based on the customer's social media activity, the generative AI adds related content. For example, content reflecting the customer's requirements expressed on social media is added. Content is added by referring to the customer's feedback on social media. By analyzing the customer's social media activity, related content can be provided. Some or all of the above-described processing in the addition unit may be performed using AI, or may be performed without using AI. For example, the addition unit may use an AI model for analyzing the customer's social media activity to analyze the customer's social media activity and add related content. Specifically, the addition unit receives the customer's social media activity data (e.g., SNS post text, comments, number of likes, number of shares, post date/time, hashtags, etc., as structured data) as input. The addition unit vectorizes post text using natural language processing algorithms (e.g., Transformer encoder, BERT, etc.), and extracts requirement/feedback patterns using sentiment analysis and topic extraction algorithms (e.g., LDA topic model, clustering). The addition unit lists frequent requirements and highly rated feedback with priority scores and generates candidate content for addition. Examples of AI input include “SNS post: request for cloud integration, 100 likes” and “SNS comment: request for security enhancement, 50 shares”. Examples of AI output include prioritized structured data such as “Addition candidate: cloud integration function (priority 0.9), security enhancement (priority 0.8)”. Based on the social media analysis results, the addition unit automatically selects the addition method (e.g., automatic merging into template, insertion into requirement section, custom section generation, etc.) and reflects it in the project plan draft. Internally, the AI model can also combine time-series analysis and correlation analysis between SNS activity and project outcomes (e.g., relationship between requirement reflection rate and customer satisfaction). In subsequent processing, the added content is passed to the generation unit and reflected when generating the project plan draft. As a technical effect, the addition unit, unlike conventional manual SNS monitoring and subjective judgment, achieves optimal content addition for each customer, improved requirement reflection rate, and homogenization of plan quality through AI-based activity analysis and automatic prioritization. Application fields include IT system development, customer response in service industries, custom product design in manufacturing, marketing, and other industries where SNS activity utilization is important. Furthermore, variations of the AI model can realize time-series trend analysis of SNS activity and comparison of requirement similarity among multiple SNS platforms. Thus, the addition unit goes beyond mere automation to achieve technical improvement of the information addition process and enhancement of customer satisfaction.

The generation unit can estimate a user's emotion and adjust the expression method of the project plan to be generated based on the estimated emotion of the user. For example, the generation unit estimates the user's emotion and adjusts the expression method of the project plan to be generated according to the estimated emotion. The generation unit uses generative AI to estimate the user's emotion. The generative AI, for example, uses an emotion estimation algorithm to estimate the user's emotion. The generative AI analyzes data such as the user's facial expressions, voice, and text to calculate an emotion score. For example, if the user is feeling stressed, a concise and easy-to-understand expression method is adopted. If the user is focused, an expression method including detailed technical information is adopted. If the user is tired, a visually easy-to-read expression method is adopted. By adjusting the expression method of the project plan based on the user's emotion, it is possible to provide an expression method suitable for the user. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the generation unit may be performed using AI, or may be performed without using AI. For example, the generation unit may use an AI model for estimating the user's emotion to estimate the user's emotion and adjust the expression method of the project plan to be generated. Specifically, the generation unit simultaneously receives multimodal input data for user emotion estimation (e.g., RGB tensor of facial image (224×224×3), time-series array of voice waveform (sampling rate 16 kHz, length 2 seconds), token sequence of chat text (up to 512 tokens)). The generation unit extracts facial features (e.g., eye opening/closing, movement of mouth corners, shape of eyebrows, etc.) from facial images using a convolutional neural network, extracts prosodic features (e.g., pitch, speech rate, intonation) from voice data after spectrogram conversion using a recurrent neural network or Transformer encoder, and generates contextual feature vectors from text data using a pre-trained large language model. The generation unit integrates these feature vectors with a multilayer perceptron and finally outputs an “emotion score” (e.g., stress level 0.85, concentration level 0.60, fatigue level 0.30, etc., as continuous values from 0 to 1). Examples of AI input include “Facial image: tense expression, voice: sighing, text: ‘I'm tired today’” and “Facial image: serious expression, voice: clear speech, text: ‘I want to learn more’”. Examples of AI output include emotion score vectors such as “stress level 0.80, concentration level 0.20, fatigue level 0.70” and “stress level 0.10, concentration level 0.90, fatigue level 0.10”. Based on the emotion score, the expression control module executes rule-based control such as “if stress level>0.7, use concise expression; if concentration level>0.8, add detailed technical information; if fatigue level>0.6, use visually oriented expression with diagrams and icons”. Multiple expression formats (e.g., text summary, detailed explanation, diagram, bullet points, infographic, etc.) are prepared for the generated project plan, and the optimal expression method is automatically selected according to the user's emotional state. Internally, the AI model uses cross-entropy loss or MSE loss for training the emotion estimation unit, combining supervised and self-supervised learning. In subsequent processing, the expression method is reflected when outputting the generated project plan and passed to the user interface or file output module. As a technical effect, the generation unit dynamically optimizes the expression method according to the user's real-time emotional state, unlike conventional uniform expression methods, thereby improving information comprehension, reducing stress, and increasing learning continuation rates. Application fields include e-learning, corporate training, medical education, school education, project management, and other document generation fields where individual optimization is required. Furthermore, variations of emotion estimation AI include estimation using only facial images, only voice, only text, or multimodal estimation combining these, allowing flexible configuration according to usage environment and privacy requirements. Thus, the generation unit goes beyond mere automation to achieve technical improvement of the project plan generation process and qualitative enhancement of user experience.

The generation unit can adjust the level of detail of the project plan to be generated based on the importance of the project at the time of generation. For example, the generation unit adjusts the level of detail of the project plan to be generated based on the importance of the project at the time of generation. The generation unit uses generative AI to adjust the level of detail of the project plan to be generated based on the importance of the project. The generative AI, for example, uses a text generative AI (e.g., LLM) to adjust the level of detail of the project plan to be generated based on the importance of the project. For highly important projects, the generative AI generates a detailed project plan. For example, for less important projects, a concise project plan is generated. The project plan is generated with the necessary information appropriately included according to the importance of the project. By adjusting the level of detail of the project plan based on the importance of the project, an appropriate project plan can be provided. Some or all of the above-described processing in the generation unit may be performed using AI, or may be performed without using AI. For example, the generation unit may use an AI model for adjusting the level of detail of the project plan to be generated based on the importance of the project. Specifically, the generation unit receives project importance information (e.g., importance score 0-1, priority label, executive-designated important project flag, etc., as structured data) as input. Based on the importance score, the generation unit automatically adjusts the detail parameters of the generated project plan (e.g., number of sections, length of explanations, presence of attachments, frequency of diagram insertion, etc.). Examples of AI input include “Importance: 0.95, priority: highest” and “Importance: 0.30, priority: normal”. Examples of AI output include project plan drafts with specified detail levels such as “Detail: all sections covered+detailed explanation+many diagrams” and “Detail: key points only+brief explanation”. The detail control module executes rule-based control such as “if importance>0.8, generate all sections in detail; if 0.5-0.8, generate main sections in detail and others as key points; if less than 0.5, generate only key points”. Internally, the AI model combines a mapping table between importance score and plan detail level and parameter optimization of the generation algorithm (e.g., output length control of autoregressive generation models). In subsequent processing, the generated project plan is passed to the user interface or file output module and proceeds to review or approval processes. As a technical effect, the generation unit, unlike conventional uniform detail level settings, achieves homogenization of plan quality, improved creation efficiency, and optimized resource allocation by flexible optimization of detail level according to the importance of each project. Application fields include IT system development, construction, manufacturing, research and development, management, and other industries with diverse project importance. Furthermore, variations of the AI model can realize dynamic detail adjustment according to time-series changes in importance and optimization of detail balance among multiple projects. Thus, the generation unit goes beyond mere automation to achieve technical improvement of the project plan generation process and advanced quality management.

The generation unit can apply different generation algorithms according to the project category at the time of generation. For example, the generation unit applies different generation algorithms according to the project category at the time of generation. The generation unit uses generative AI to apply different generation algorithms according to the project category. The generative AI, for example, uses a text generative AI (e.g., LLM) to apply different generation algorithms according to the project category. The generative AI applies generation algorithms for IT projects and generates project plans reflecting technical requirements. For example, generation algorithms for construction projects are applied to generate project plans reflecting construction period management. Generation algorithms for marketing projects are applied to generate project plans reflecting market analysis. By applying generation algorithms according to the project category, appropriate project plans can be provided. Some or all of the above-described processing in the generation unit may be performed using AI, or may be performed without using AI. For example, the generation unit may use an AI model for applying different generation algorithms according to the project category to apply different generation algorithms according to the project category. Specifically, the generation unit receives project category information (e.g., IT, construction, manufacturing, marketing, etc., as category labels) as input. The generation unit automatically selects optimized generation algorithms for each category (e.g., for IT: Transformer-based technical requirement generation; for construction: rule-based+decision tree for construction period management generation; for marketing: natural language processing+clustering for market analysis generation, etc.) and generates project plan drafts. Examples of AI input include “Category: IT, template data: full text” and “Category: construction, template data: full text”. Examples of AI output include category-specific project plan drafts such as “IT generation result: technical requirements=cloud integration required, detailed API design” and “Construction generation result: construction period management=12 months, with schedule chart”. By switching generation rules and feature sets for each category, the generation unit can reflect industry-specific requirements and management items without omission. Internally, the AI model utilizes meta-learning methods (e.g., category determination network) and ensemble learning (e.g., weighted average of multiple generation models) to achieve optimization according to project attributes. In subsequent processing, the generated category-specific project plans are passed to the user interface or file output module and proceed to review or approval processes. As a technical effect, the generation unit, unlike conventional uniform generation algorithm application, greatly improves the suitability, quality, and creation efficiency of the plan by flexible model selection and optimization according to each project's characteristics. Application fields include IT system development, construction, manufacturing, marketing, and other project-based operations with high diversity in category. Furthermore, variations of the generation algorithm can realize hybrid generation across multiple categories and dynamic model switching according to changes in category attributes. Thus, the generation unit goes beyond mere automation to achieve technical improvement and enhanced flexibility in the project plan generation process.

The generation unit can estimate a user's emotion and adjust the length of the project plan to be generated based on the estimated emotion of the user. For example, the generation unit estimates the user's emotion and adjusts the length of the project plan to be generated according to the estimated emotion. The generation unit uses generative AI to estimate the user's emotion. The generative AI, for example, uses an emotion estimation algorithm to estimate the user's emotion. The generative AI analyzes data such as the user's facial expressions, voice, and text to calculate an emotion score. For example, if the user is in a hurry, a short project plan focusing on key points is generated. If the user is relaxed, a longer project plan including detailed explanations is generated. If the user is excited, a project plan with visually stimulating effects is generated. By adjusting the length of the project plan based on the user's emotion, a project plan suitable for the user can be provided. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the generation unit may be performed using AI, or may be performed without using AI. For example, the generation unit may use an AI model for estimating the user's emotion to estimate the user's emotion and adjust the length of the project plan to be generated. Specifically, the generation unit receives multimodal input data for user emotion estimation (e.g., RGB tensor of facial image, time-series array of voice waveform, token sequence of chat text) and applies a convolutional neural network to facial images, spectrogram+recurrent neural network to voice, and Transformer encoder to text to extract feature vectors. The generation unit integrates these feature vectors and calculates emotion scores (e.g., hurry level 0.90, relaxation level 0.80, excitement level 0.70, etc.). Examples of AI input include “Facial image: tense expression, voice: fast speech, text: ‘I'm in a hurry’” and “Facial image: calm expression, voice: slow speech, text: ‘I want to read carefully’”. Examples of AI output include emotion score vectors such as “hurry level 0.85, relaxation level 0.10, excitement level 0.90” and “hurry level 0.10, relaxation level 0.90, excitement level 0.10”. Based on the emotion score, the length control module executes rule-based control such as “if hurry level>0.7, generate short sentences with only key points; if relaxation level>0.7, generate long sentences with detailed explanations; if excitement level>0.7, generate with visual effects”. The generated project plan automatically adjusts length parameters (e.g., number of sections, number of characters in explanations, frequency of diagram insertion, etc.) to achieve optimal length according to the user's emotional state. Internally, the AI model uses cross-entropy loss or MSE loss for training the emotion estimation unit, combining supervised and self-supervised learning. In subsequent processing, the length adjustment result is reflected when outputting the generated project plan and passed to the user interface or file output module. As a technical effect, the generation unit dynamically optimizes the length of the project plan according to the user's real-time emotional state, unlike conventional uniform length settings, thereby improving information comprehension, reducing stress, and increasing learning continuation rates. Application fields include e-learning, corporate training, medical education, school education, project management, and other document generation fields where individual optimization is required. Furthermore, variations of emotion estimation AI include estimation using only facial images, only voice, only text, or multimodal estimation combining these, allowing flexible configuration according to usage environment and privacy requirements. Thus, the generation unit goes beyond mere automation to achieve technical improvement of the project plan generation process and qualitative enhancement of user experience.

The generation unit can determine the priority of the project plan to be generated based on the submission timing of the project at the time of generation. For example, the generation unit determines the priority of the project plan to be generated based on the submission timing of the project at the time of generation. The generation unit uses generative AI to determine the priority of the project plan to be generated based on the submission timing of the project. The generative AI, for example, uses a text generative AI (e.g., LLM) to determine the priority of the project plan to be generated based on the submission timing of the project. The generative AI preferentially generates project plans for projects with imminent submission deadlines. For example, project plans for projects with distant submission deadlines are generated later. The level of detail of the project plan to be generated is adjusted according to the submission deadline. By determining the priority of the project plan based on the submission timing of the project, project plans can be provided according to the submission deadline. Some or all of the above-described processing in the generation unit may be performed using AI, or may be performed without using AI. For example, the generation unit may use an AI model for determining the priority of the project plan to be generated based on the submission timing of the project. Specifically, the generation unit receives project submission timing information (e.g., submission deadline date, remaining days, priority label, etc., as structured data) as input. Based on the submission timing data, the generation unit calculates a priority score (e.g., higher score for fewer remaining days) and dynamically adjusts the generation order and level of detail of the project plan. Examples of AI input include “Submission deadline: 2024-07-01, remaining days: 3” and “Submission deadline: 2024-08-15, remaining days: 30”. Examples of AI output include prioritized generation instruction data such as “Priority: high, detail: key points only” and “Priority: low, detail: with detailed explanation”. If the submission deadline is near, the generation unit preferentially generates concise project plans focusing on key points; if there is sufficient time, detailed explanations and supplementary information are included. Internally, the AI model combines mapping rules between submission timing and priority and scheduling algorithms (e.g., priority queue, Gantt chart integration) to optimize the generation order. In subsequent processing, the generated prioritized project plans are passed to the user interface or file output module and used for deadline management and review. As a technical effect, the generation unit, unlike conventional uniform generation order and detail level settings, achieves improved deadline compliance rate, work efficiency, and homogenization of plan quality by flexible project plan generation according to submission timing. Application fields include IT system development, construction, manufacturing, research and development, and other project-based operations where deadline management is important. Furthermore, variations of submission timing-linked AI can realize automatic reminders for progress delays and optimization of priorities among multiple projects. Thus, the generation unit goes beyond mere automation to achieve technical improvement of the project plan generation process and advanced deadline management.

The generation unit can adjust the order of the project plans to be generated based on the relevance of the project at the time of generation. For example, the generation unit adjusts the order of the project plans to be generated based on the relevance of the project at the time of generation. The generation unit uses generative AI to adjust the order of the project plans to be generated based on the relevance of the project. The generative AI, for example, uses a text generative AI (e.g., LLM) to adjust the order of the project plans to be generated based on the relevance of the project. The generative AI preferentially generates project plans for highly relevant projects. For example, project plans for less relevant projects are generated later. The order of the project plans to be generated is adjusted according to the relevance of the project. By adjusting the order of the project plans based on the relevance of the project, highly relevant project plans can be provided. Some or all of the above-described processing in the generation unit may be performed using AI, or may be performed without using AI. For example, the generation unit may use an AI model for adjusting the order of the project plans to be generated based on the relevance of the project. Specifically, the generation unit receives project relevance information (e.g., similar project ID, relevance score, number of common requirements, past collaboration history, etc., as structured data) as input. Based on the relevance score, the generation unit dynamically adjusts the generation order of the project plans and eliminates or integrates duplicate content. Examples of AI input include “Related project ID: A123, relevance: 0.95” and “Related project ID: B456, relevance: 0.30”. Examples of AI output include order/integration instruction data such as “Generation order: A123 prioritized, B456 postponed” and “Integration instruction: integrate A123 and C789”. The relevance control module executes rule-based control such as “if relevance>0.8, prioritize generation; if 0.5-0.8, generate simultaneously; if less than 0.5, postpone”. Internally, the AI model combines relevance score calculation (e.g., cosine similarity, requirement match rate) and generation order optimization algorithms (e.g., priority-based topological sort). In subsequent processing, the generated project plans are passed to the user interface or file output module and used for project management and review. As a technical effect, the generation unit, unlike conventional uniform generation order settings, achieves prevention of duplicate plan creation, improved work efficiency, and enhanced information consistency by flexible optimization of order according to project relevance. Application fields include IT system development, construction, manufacturing, research and development, and other industries where multiple projects are linked or similar. Furthermore, variations of relevance-linked AI can realize optimization of the entire project network and dynamic order adjustment according to time-series changes in relevance. Thus, the generation unit goes beyond mere automation to achieve technical improvement of the project plan generation process and advanced project management.

The system according to the embodiment is not limited to the examples described above and can be variously modified as follows, for example. Specifically, the system has extensibility that allows flexible modification of the configuration of various AI modules and data flows. The system can independently implement each functional module, such as the learning unit, extraction unit, addition unit, generation unit, and feedback collection unit, on a distributed microservices architecture. The system can utilize parallel computing clusters using GPUs and cloud-based AI inference platforms to dynamically optimize resource allocation according to computational load and data scale. The system can automatically select the type of AI model (e.g., Transformer series, CNN, RNN, decision tree, rule-based, etc.) and learning method (e.g., supervised learning, self-supervised learning, transfer learning, reinforcement learning, etc.) according to project attributes and user requirements. The system can flexibly switch the type of input data (e.g., text, image, voice, time-series data, structured data, etc.) and data preprocessing methods (e.g., normalization, tokenization, feature extraction, data augmentation, etc.). The system can link the output of AI models (e.g., score vectors, labels, probability distributions, structured templates, etc.) to subsequent processing modules, realizing various usage forms such as threshold judgment, rule-based branching, and immediate reflection in the user interface. The system can integrally manage multidimensional metadata such as project progress, user emotional state, geographic distribution, industry/scale, submission timing, relevance, etc., and optimize the operating parameters of each module in real time. As a technical effect, the system, unlike conventional fixed workflows and single AI model application, greatly improves the flexibility, extensibility, efficiency, and quality of the project plan creation process by dynamically optimizing the configuration and operation of the entire system according to diverse project and user requirements and situations. Application fields include IT system development, construction, manufacturing, research and development, education, medical care, administrative document creation, and all fields requiring project-based operations or document generation. Furthermore, variations of system configuration can realize operation in on-premises, cloud, or hybrid environments, distributed cooperative processing between multiple sites, functional expansion via external API integration, and access control/log management according to security requirements. Thus, the system goes beyond mere automation to achieve technical improvement of the project plan creation and management process and overall business optimization.

The project plan creation system may further include a feedback collection unit. The feedback collection unit provides a draft version of the project plan to the customer and collects feedback from the customer. For example, an interface is provided that allows the customer to input comments or requests for modification regarding the content of the plan. The feedback collection unit analyzes the collected feedback and identifies points for improvement in the plan. As a result, a project plan more suited to the customer's requirements can be created. The feedback collection unit can also reflect the customer's feedback in real time and update the draft version of the plan. For example, if the customer adds a specific technical requirement, that requirement is immediately reflected in the plan. This facilitates smooth communication with the customer and improves the quality of the plan. Specifically, the feedback collection unit receives feedback data from the customer (e.g., text comments, modification instructions, evaluation scores, attached files, etc., as structured or unstructured data) as input. The feedback collection unit vectorizes comment text using natural language processing algorithms (e.g., Transformer encoder, BERT, etc.), and classifies and organizes feedback content using requirement extraction algorithms (e.g., key phrase extraction, request clustering, sentiment analysis, etc.). The feedback collection unit uses AI models to determine importance (e.g., urgency score of requirements, technical impact score, etc.) and automatically identifies modification points (e.g., mapping to plan sections), generating a list of improvement points. Examples of AI input include “Comment: Please add API integration function” and “Modification request: Prefer to move up the delivery date by two weeks”. Examples of AI output include prioritized improvement instruction data such as “Additional requirement: API integration (priority 0.9)” and “Modification instruction: delivery date change (urgency 0.8)”. The feedback collection unit immediately links improvement instruction data to the addition unit or generation unit, automatically updates the plan draft, and manages versions. Internally, the AI model can also combine time-series analysis of feedback content and correlation analysis with customer attributes and past history (e.g., relationship between requirement reflection rate and customer satisfaction). In subsequent processing, the updated plan is immediately reflected in the customer interface and proceeds to re-feedback or approval processes. As a technical effect, the feedback collection unit, unlike conventional manual requirement management and subjective judgment, achieves optimal plan improvement for each customer, improved requirement reflection rate, homogenization of plan quality, and greatly improved communication efficiency through AI-based feedback analysis and automatic reflection. Application fields include IT system development, contract development, custom product design in manufacturing, customer response history management in service industries, and other industries where customer feedback utilization is important. Furthermore, variations of the AI model can realize time-series trend analysis of feedback content, comparison of requirement similarity among multiple customers, and automatic template generation according to feedback content. Thus, the feedback collection unit goes beyond mere automation to achieve technical improvement of the feedback management process and enhancement of customer satisfaction.

The learning unit can learn best practices from different industries in the creation of project plans. For example, best practices for project plans in the IT industry are learned and applied to other industries. Best practices for project plans in the construction industry are learned and utilized for resource management and schedule management. Best practices for project plans in the marketing industry are learned and reflected in customer analysis and market research. By incorporating knowledge from different industries, more comprehensive and effective project plans can be created. The learning unit can also integrate best practices from different industries, extract common parts, and save them as templates. This enables efficient creation of project plans while utilizing knowledge from different industries. Specifically, the learning unit receives project plan data for each industry (e.g., IT, construction, manufacturing, marketing, etc., as category-labeled text data, structured templates, past case databases, etc.) as input. The learning unit extracts features such as “project purpose,” “schedule management,” “resource allocation,” “customer analysis,” and “market research” from each industry's plan using natural language processing algorithms (e.g., Transformer encoder, BERT, etc.) and feature extraction algorithms (e.g., TF-IDF, n-gram analysis, section classifier, etc.). The learning unit automatically classifies and organizes common and industry-specific parts using cross-industry clustering (e.g., K-means clustering, principal component analysis) and similarity calculation (e.g., cosine similarity). Examples of AI input include “Industry: IT, plan data: full text” and “Industry: construction, plan data: full text”. Examples of AI output include structured templates such as “Common parts: purpose=quality improvement, schedule management=use of Gantt chart” and “Industry-specific parts: IT=detailed API design, construction=on-site safety management”. The learning unit saves extracted common parts in a template database and manages industry-specific parts with tags to enhance knowledge sharing and reusability across industries. Internally, the AI model utilizes transfer learning and meta-learning methods to apply knowledge learned in one industry to plan generation in other industries. In subsequent processing, the extraction unit and generation unit refer to these templates and automatically reflect them when generating plan drafts. As a technical effect, the learning unit, unlike conventional industry-specific know-how accumulation, achieves efficiency in plan creation, homogenization of quality, and optimization of knowledge transfer through AI-based cross-industry knowledge extraction and templating. Application fields include IT system development, construction, manufacturing, marketing, research and development, and other project-based operations where cross-industry knowledge utilization is required. Furthermore, variations of the AI model can realize automatic comparison of best practices between industries, time-series analysis of industry trends, and automatic extraction of industry-specific requirements. Thus, the learning unit goes beyond mere automation to achieve technical improvement of the plan creation process and advanced knowledge utilization.

The extraction unit can utilize risk management data from past projects when generating a draft version of a project plan. For example, risks that occurred in past projects and their countermeasures are extracted and reflected in the current project plan. Based on risk management data, the probability of occurrence and impact of risks are evaluated, and appropriate countermeasures are included in the plan. This strengthens project risk management and improves the reliability of the plan. The extraction unit can also save risk management data as templates and reuse them when creating future project plans. For example, a common risk management template is created and applied to different projects. This improves the efficiency of risk management and ensures consistent plan quality. Specifically, the extraction unit receives risk management data from past projects (e.g., list of risk occurrence cases, countermeasure details, probability/impact scores, risk categories, etc., as structured databases) as input. The extraction unit automatically extracts risk details and countermeasures using natural language processing algorithms (e.g., Transformer encoder, BERT, etc.) and feature extraction algorithms (e.g., TF-IDF, n-gram analysis, section classifier, etc.), and quantifies the probability of occurrence and impact as numerical vectors. The extraction unit recalculates the probability of occurrence and impact according to the current project attributes (e.g., scale, industry, geographic conditions, etc.) using risk evaluation algorithms (e.g., Bayesian estimation, decision tree, logistic regression, etc.), and automatically selects optimal countermeasures. Examples of AI input include “Risk case: delivery delay, probability 0.3, impact 0.7” and “Risk case: requirement change, probability 0.2, impact 0.6”. Examples of AI output include reliability-scored countermeasure lists such as “Recommended countermeasure: strengthen progress management (confidence 0.9), freeze requirements (confidence 0.8)”. The extraction unit saves extracted risk management templates in a database and realizes standardization and efficiency of risk management by reusing them when creating future project plans. Internally, the AI model can also combine time-series analysis of risk occurrence patterns and correlation analysis with project attributes (e.g., industry-specific risk trends, geographic factor-based risk distribution, etc.). In subsequent processing, the extracted risk management data is passed to the addition unit or generation unit and reflected when generating the plan draft. As a technical effect, the extraction unit, unlike conventional manual risk management and subjective judgment, achieves advanced risk management, homogenization of plan quality, and improved creation efficiency through AI-based risk data analysis and automatic countermeasure selection. Application fields include IT system development, construction, manufacturing, research and development, infrastructure development, and other project-based operations where risk management is important. Furthermore, variations of the AI model can realize anomaly detection of risk occurrence, comparison of risk similarity among multiple projects, and automatic optimization of risk countermeasures. Thus, the extraction unit goes beyond mere automation to achieve technical improvement of the risk management process and enhancement of plan quality.

The addition unit can reflect the customer's past successful project cases in the draft version of the project plan. For example, elements of projects in which the customer succeeded in the past are analyzed and incorporated into the current plan. Methods of resource allocation and schedule management from successful cases are referenced. This enables the creation of a project plan that leverages the customer's successful experiences. The addition unit can also save successful cases as templates and apply them to other projects. For example, a template of successful cases is created and applied to different projects. This enables broad utilization of knowledge from successful cases and improves the quality of the plan. Specifically, the addition unit receives data on the customer's past successful project cases (e.g., list of success factors, resource allocation patterns, schedule management methods, deliverable quality indicators, etc., as structured databases) as input. The addition unit automatically extracts success factors and management methods using natural language processing algorithms (e.g., Transformer encoder, BERT, etc.) and feature extraction algorithms (e.g., TF-IDF, n-gram analysis, section classifier, etc.), and calculates similarity with current project attributes (e.g., scale, industry, geographic conditions, etc.). Based on the similarity score, the addition unit automatically selects the optimal successful case template and reflects it in the plan draft. Examples of AI input include “Successful case: cloud integration introduction, resource allocation=standard configuration, schedule=6 months” and “Successful case: strengthened on-site safety management, deliverable quality=high”. Examples of AI output include suitability-scored successful case lists such as “Addition candidate: cloud integration introduction (suitability 0.9), strengthened on-site safety management (suitability 0.8)”. The addition unit saves extracted and selected successful case templates in a database to enhance reusability for other projects. Internally, the AI model can also combine time-series analysis of success factors and correlation analysis with project outcomes (e.g., relationship between successful case reflection rate and deliverable quality). In subsequent processing, the added successful case content is passed to the generation unit and reflected when generating the plan draft. As a technical effect, the addition unit, unlike conventional manual utilization of successful cases and subjective judgment, achieves homogenization of plan quality, improved creation efficiency, and enhanced customer satisfaction through AI-based analysis and automatic application of successful cases. Application fields include IT system development, construction, manufacturing, research and development, service industries, and other project-based operations where utilization of successful cases is important. Furthermore, variations of the AI model can realize time-series trend analysis of successful cases, comparison of success factors among multiple customers, and automatic templating of successful cases. Thus, the addition unit goes beyond mere automation to achieve technical improvement of the successful case utilization process and enhancement of plan quality.

The generation unit can reflect the opinions of project stakeholders when generating a draft version of the project plan. For example, feedback from major project stakeholders is collected and reflected in the plan. The project's purpose, schedule, and resource allocation are adjusted based on stakeholder opinions. This enables the creation of a project plan that meets stakeholder expectations. The generation unit can also save stakeholder opinions as templates and reuse them when creating future project plans. For example, a template reflecting stakeholder opinions is created and applied to different projects. This enables efficient incorporation of stakeholder opinions and improves the quality of the plan. Specifically, the generation unit receives opinion data from stakeholders (e.g., text comments, modification requests, evaluation scores, approval/disapproval flags, etc., as structured or unstructured data) as input. The generation unit classifies and organizes opinion content using natural language processing algorithms (e.g., Transformer encoder, BERT, etc.) and requirement extraction algorithms (e.g., key phrase extraction, request clustering, sentiment analysis, etc.), and maps them to each section of the project plan (e.g., purpose, schedule, resource allocation, etc.). The generation unit uses AI models to determine importance (e.g., priority score of opinions, technical impact score, etc.) and automatically identifies modification points, reflecting them in the plan draft. Examples of AI input include “Comment: Please enhance resource allocation” and “Request: Prefer to extend the delivery date by one month”. Examples of AI output include prioritized modification instruction data such as “Modification instruction: enhance resource allocation (priority 0.8), extend delivery date (priority 0.7)”. The generation unit saves reflected stakeholder opinions in a template database and realizes standardization and efficiency of opinion reflection by reusing them when creating future project plans. Internally, the AI model can also combine time-series analysis of opinion content and correlation analysis with project outcomes (e.g., relationship between opinion reflection rate and deliverable quality). In subsequent processing, the generated plan is passed to the user interface or file output module and proceeds to review or approval processes. As a technical effect, the generation unit, unlike conventional manual opinion reflection and subjective judgment, achieves homogenization of plan quality, improved creation efficiency, and enhanced stakeholder satisfaction through AI-based opinion analysis and automatic reflection. Application fields include IT system development, construction, manufacturing, research and development, service industries, and other project-based operations where utilization of stakeholder opinions is important. Furthermore, variations of the AI model can realize time-series trend analysis of opinion content, comparison of opinion similarity among multiple stakeholders, and automatic generation of opinion reflection templates. Thus, the generation unit goes beyond mere automation to achieve technical improvement of the opinion reflection process and enhancement of plan quality.

The learning unit can estimate a user's emotion and adjust the order of presentation of learning data based on the estimated emotion of the user. For example, if the user is relaxed, detailed technical information is presented first. If the user is feeling stressed, concise and easy-to-understand information is presented first. If the user is focused, important information is preferentially presented. By adjusting the order of presentation of learning data according to the user's emotion, effective learning can be supported. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the learning unit may be performed using AI, or may be performed without using AI. For example, the learning unit may use an AI model for estimating the user's emotion to estimate the user's emotion and adjust the order of presentation of learning data. Specifically, the learning unit simultaneously receives multimodal input data for user emotion estimation (e.g., RGB tensor of facial image (224×224×3), time-series array of voice waveform (sampling rate 16 kHz, length 2 seconds), token sequence of chat text (up to 512 tokens)). The learning unit extracts facial features (e.g., eye opening/closing, movement of mouth corners, shape of eyebrows, etc.) from facial images using a convolutional neural network, extracts prosodic features (e.g., pitch, speech rate, intonation) from voice data after spectrogram conversion using a recurrent neural network or Transformer encoder, and generates contextual feature vectors from text data using a pre-trained large language model. The learning unit integrates these feature vectors with a multilayer perceptron and finally outputs an “emotion score” (e.g., relaxation level 0.80, stress level 0.70, concentration level 0.90, etc., as continuous values from 0 to 1). Examples of AI input include “Facial image: calm expression, voice: slow speech, text: ‘I want to read carefully’” and “Facial image: tense expression, voice: sighing, text: ‘I'm tired today’”. Examples of AI output include emotion score vectors such as “relaxation level 0.85, stress level 0.10, concentration level 0.60” and “relaxation level 0.10, stress level 0.90, concentration level 0.20”. Based on the emotion score, the presentation order control module executes rule-based control such as “if relaxation level>0.7, prioritize detailed technical information; if stress level>0.7, prioritize concise information; if concentration level>0.7, prioritize important information”. Learning data is managed as tagged structured data (e.g., sections with detail labels, explanations with importance scores, key point summaries, etc.), and the learning unit dynamically adjusts the order and content according to priority. Internally, the AI model uses cross-entropy loss or MSE loss for training the emotion estimation unit, combining supervised and self-supervised learning. In subsequent processing, the presentation order adjustment result is reflected in the user interface to optimize the user experience. As a technical effect, the learning unit dynamically optimizes the presentation order according to the user's real-time emotional state, unlike conventional uniform presentation order, thereby improving information comprehension, reducing stress, and increasing learning continuation rates. Application fields include e-learning, corporate training, medical education, school education, and other educational fields where individual optimization is required. Furthermore, variations of emotion estimation AI include estimation using only facial images, only voice, only text, or multimodal estimation combining these, allowing flexible configuration according to usage environment and privacy requirements. Thus, the learning unit goes beyond mere automation to achieve technical improvement of the learning data presentation process and qualitative enhancement of user experience.

The extraction unit can estimate a user's emotion and adjust the level of detail of content to be extracted based on the estimated emotion of the user. For example, if the user is relaxed, content including detailed technical information is extracted. If the user is feeling stressed, concise and easy-to-understand content is extracted. If the user is focused, important information is preferentially extracted. By adjusting the level of detail of content according to the user's emotion, effective information provision can be supported. Emotion estimation is realized, for example, by using an emotion estimation function with an emotion engine or generative AI. The generative AI may be a text generative AI (e.g., LLM) or a multimodal generative AI, but is not limited to such examples. Some or all of the above-described processing in the extraction unit may be performed using AI, or may be performed without using AI. For example, the extraction unit may use an AI model for estimating the user's emotion to estimate the user's emotion and adjust the level of detail of content to be extracted. Specifically, the extraction unit simultaneously receives multimodal input data for user emotion estimation (e.g., RGB tensor of facial image (224×224×3), time-series array of voice waveform (sampling rate 16 kHz, length 2 seconds), token sequence of chat text (up to 512 tokens)). The extraction unit extracts facial features (e.g., eye opening/closing, movement of mouth corners, shape of eyebrows, etc.) from facial images using a convolutional neural network, extracts prosodic features (e.g., pitch, speech rate, intonation) from voice data after spectrogram conversion using a recurrent neural network or Transformer encoder, and generates contextual feature vectors from text data using a pre-trained large language model. The extraction unit integrates these feature vectors with a multilayer perceptron and finally outputs an “emotion score” (e.g., relaxation level 0.80, stress level 0.70, concentration level 0.90, etc., as continuous values from 0 to 1). Examples of AI input include “Facial image: calm expression, voice: slow speech, text: ‘I want to read carefully’” and “Facial image: tense expression, voice: sighing, text: ‘I'm tired today’”. Examples of AI output include emotion score vectors such as “relaxation level 0.85, stress level 0.10, concentration level 0.60” and “relaxation level 0.10, stress level 0.90, concentration level 0.20”. Based on the emotion score, the detail control module executes rule-based control such as “if relaxation level>0.7, prioritize detailed technical information; if stress level>0.7, prioritize concise information; if concentration level>0.7, prioritize important information”. Content to be extracted is managed as structured data with detail labels (e.g., detailed explanation, key point summary, diagram, etc.), and the extraction unit dynamically adjusts the level of detail and content according to priority. Internally, the AI model uses cross-entropy loss or MSE loss for training the emotion estimation unit, combining supervised and self-supervised learning. In subsequent processing, the detail adjustment result is passed to the addition unit or generation unit and reflected when generating the plan draft. As a technical effect, the extraction unit dynamically optimizes the level of detail according to the user's real-time emotional state, unlike conventional uniform detail settings, thereby improving information comprehension, reducing stress, and increasing learning continuation rates. Application fields include e-learning, corporate training, medical education, school education, and other educational fields where individual optimization is required. Furthermore, variations of emotion estimation AI include estimation using only facial images, only voice, only text, or multimodal estimation combining these, allowing flexible configuration according to usage environment and privacy requirements. Thus, the extraction unit goes beyond mere automation to achieve technical improvement of the information extraction process and qualitative enhancement of user experience.

The addition unit can estimate the user's emotion and adjust the format of the content to be added based on the estimated emotion of the user. For example, when the user is relaxed, the addition unit adds text-based content containing detailed technical information. When the user is feeling stressed, the addition unit adds concise and visually easy-to-understand graphic content. When the user is focused, the addition unit adds presentation-style content containing important information. By adjusting the format of the content according to the user's emotion, effective information provision can be supported. Emotion estimation is realized, for example, by using an emotion estimation function implemented with an emotion engine or generative AI. The generative AI may be a text generation AI (e.g., LLM) or a multimodal generative AI, but is not limited to these examples. Some or all of the above-described processing in the addition unit may be performed using AI, or may be performed without using AI. For example, the addition unit may use an AI model for estimating the user's emotion, estimate the user's emotion, and adjust the format of the content to be added. Specifically, the addition unit receives multimodal input data for emotion estimation (e.g., RGB tensor of a facial image (224×224×3), time-series array of audio waveform (sampling rate 16 kHz, length 2 seconds), token sequence of chat text (up to 512 tokens)) simultaneously. The addition unit extracts facial expression features (e.g., eye opening/closing, mouth corner movement, eyebrow shape, etc.) from facial images using a convolutional neural network, extracts prosodic features (e.g., pitch, speech rate, intonation) from audio data after spectrogram conversion using a recurrent neural network or Transformer encoder, and generates contextual feature vectors from text data using a pre-trained large language model. The addition unit integrates these feature vectors using a multilayer perceptron and finally outputs an “emotion score” (e.g., relaxation level 0.80, stress level 0.70, concentration level 0.90, etc., as continuous values from 0 to 1). Examples of AI input include “facial image: calm expression, audio: slow speech, text: ‘I want to read carefully’” and “facial image: tense expression, audio: sighing, text: ‘I'm tired today’”. Examples of AI output include emotion score vectors such as “relaxation level 0.85, stress level 0.10, concentration level 0.60” and “relaxation level 0.10, stress level 0.90, concentration level 0.20”. Based on the emotion score, the format control module executes rule-based control such as “if relaxation level>0.7, use detailed text format; if stress level>0.7, use graphic format; if concentration level>0.7, use presentation format”. The additional content is managed as structured data with format labels (e.g., text, graphic, presentation, diagram, etc.), and the addition unit dynamically adjusts the format and content according to priority. In the internal processing of the AI model, cross-entropy loss or MSE loss is used for training the emotion estimation unit, and supervised learning or self-supervised learning is combined. In subsequent processing, the format adjustment result is passed to the generation unit and reflected when generating the draft plan. As a technical effect, the addition unit, unlike conventional uniform format settings, dynamically optimizes the format according to the user's real-time emotional state, thereby improving information comprehension, reducing stress, and increasing learning continuation rate. Applicable fields include e-learning, corporate training, medical education, school education, and all educational fields where individual optimization is required. Furthermore, variations of the emotion estimation AI include facial image only, audio only, text only, or multimodal estimation using combinations thereof, and the configuration can be flexibly changed according to the usage environment and privacy requirements. Thus, the addition unit goes beyond mere automation to achieve technical improvement of the information addition process and qualitative enhancement of the user experience.

The generation unit can estimate the user's emotion and adjust the layout of the plan to be generated based on the estimated emotion of the user. For example, when the user is relaxed, the generation unit adopts a complex layout containing detailed information. When the user is feeling stressed, the generation unit adopts a simple and highly visible layout. When the user is focused, the generation unit adopts a layout that emphasizes important information. By adjusting the layout according to the user's emotion, effective information provision can be supported. Emotion estimation is realized, for example, by using an emotion estimation function implemented with an emotion engine or generative AI. The generative AI may be a text generation AI (e.g., LLM) or a multimodal generative AI, but is not limited to these examples. Some or all of the above-described processing in the generation unit may be performed using AI, or may be performed without using AI. For example, the generation unit may use an AI model for estimating the user's emotion, estimate the user's emotion, and adjust the layout of the plan to be generated. Specifically, the generation unit receives multimodal input data for emotion estimation (e.g., RGB tensor of a facial image (224×224×3), time-series array of audio waveform (sampling rate 16 kHz, length 2 seconds), token sequence of chat text (up to 512 tokens)) simultaneously. The generation unit extracts facial expression features (e.g., eye opening/closing, mouth corner movement, eyebrow shape, etc.) from facial images using a convolutional neural network, extracts prosodic features (e.g., pitch, speech rate, intonation) from audio data after spectrogram conversion using a recurrent neural network or Transformer encoder, and generates contextual feature vectors from text data using a pre-trained large language model. The generation unit integrates these feature vectors using a multilayer perceptron and finally outputs an “emotion score” (e.g., relaxation level 0.80, stress level 0.70, concentration level 0.90, etc., as continuous values from 0 to 1). Examples of AI input include “facial image: calm expression, audio: slow speech, text: ‘I want to read carefully’” and “facial image: tense expression, audio: sighing, text: ‘I'm tired today’”. Examples of AI output include emotion score vectors such as “relaxation level 0.85, stress level 0.10, concentration level 0.60” and “relaxation level 0.10, stress level 0.90, concentration level 0.20”. Based on the emotion score, the layout control module executes rule-based control such as “if relaxation level>0.7, use complex layout; if stress level>0.7, use simple layout; if concentration level>0.7, use emphasis layout”. The generated plan automatically adjusts layout parameters (e.g., section arrangement, font size, color scheme, chart arrangement, etc.) to achieve the optimal layout according to the user's emotional state. In the internal processing of the AI model, cross-entropy loss or MSE loss is used for training the emotion estimation unit, and supervised learning or self-supervised learning is combined. In subsequent processing, the layout adjustment result is reflected when outputting the generated plan and passed to the user interface or file output module. As a technical effect, the generation unit, unlike conventional uniform layout settings, dynamically optimizes the layout according to the user's real-time emotional state, thereby improving information comprehension, reducing stress, and increasing learning continuation rate. Applicable fields include e-learning, corporate training, medical education, school education, project management, and all document generation fields where individual optimization is required. Furthermore, variations of the emotion estimation AI include facial image only, audio only, text only, or multimodal estimation using combinations thereof, and the configuration can be flexibly changed according to the usage environment and privacy requirements. Thus, the generation unit goes beyond mere automation to achieve technical improvement of the plan generation process and qualitative enhancement of the user experience.

The generation unit can estimate the user's emotion and adjust the color scheme of the plan to be generated based on the estimated emotion of the user. For example, when the user is relaxed, the generation unit uses calm colors. When the user is feeling stressed, the generation unit uses bright colors with high visibility. When the user is focused, the generation unit uses highly contrasting colors to emphasize important information. By adjusting the color scheme according to the user's emotion, effective information provision can be supported. Emotion estimation is realized, for example, by using an emotion estimation function implemented with an emotion engine or generative AI. The generative AI may be a text generation AI (e.g., LLM) or a multimodal generative AI, but is not limited to these examples. Some or all of the above-described processing in the generation unit may be performed using AI, or may be performed without using AI. For example, the generation unit may use an AI model for estimating the user's emotion, estimate the user's emotion, and adjust the color scheme of the plan to be generated. Specifically, the generation unit receives multimodal input data for emotion estimation (e.g., RGB tensor of a facial image (224×224×3), time-series array of audio waveform (sampling rate 16 kHz, length 2 seconds), token sequence of chat text (up to 512 tokens)) simultaneously. The generation unit extracts facial expression features (e.g., eye opening/closing, mouth corner movement, eyebrow shape, etc.) from facial images using a convolutional neural network, extracts prosodic features (e.g., pitch, speech rate, intonation) from audio data after spectrogram conversion using a recurrent neural network or Transformer encoder, and generates contextual feature vectors from text data using a pre-trained large language model. The generation unit integrates these feature vectors using a multilayer perceptron and finally outputs an “emotion score” (e.g., relaxation level 0.80, stress level 0.70, concentration level 0.90, etc., as continuous values from 0 to 1). Examples of AI input include “facial image: calm expression, audio: slow speech, text: ‘I want to read carefully’” and “facial image: tense expression, audio: sighing, text: ‘I'm tired today’”. Examples of AI output include emotion score vectors such as “relaxation level 0.85, stress level 0.10, concentration level 0.60” and “relaxation level 0.10, stress level 0.90, concentration level 0.20”. Based on the emotion score, the color control module executes rule-based control such as “if relaxation level>0.7, use calm colors; if stress level>0.7, use bright colors; if concentration level>0.7, use strong contrast”. The generated plan automatically adjusts color parameters (e.g., background color, text color, highlight color, chart color scheme, etc.) to achieve the optimal color scheme according to the user's emotional state. In the internal processing of the AI model, cross-entropy loss or MSE loss is used for training the emotion estimation unit, and supervised learning or self-supervised learning is combined. In subsequent processing, the color adjustment result is reflected when outputting the generated plan and passed to the user interface or file output module. As a technical effect, the generation unit, unlike conventional uniform color settings, dynamically optimizes the color scheme according to the user's real-time emotional state, thereby improving information comprehension, reducing stress, and increasing learning continuation rate. Applicable fields include e-learning, corporate training, medical education, school education, project management, and all document generation fields where individual optimization is required. Furthermore, variations of the emotion estimation AI include facial image only, audio only, text only, or multimodal estimation using combinations thereof, and the configuration can be flexibly changed according to the usage environment and privacy requirements. Thus, the generation unit goes beyond mere automation to achieve technical improvement of the plan generation process and qualitative enhancement of the user experience.

The following briefly describes the processing flow of Example of the Embodiment. Specifically, the present system is designed as a stepwise processing flow for the entire project plan creation process using multiple AI modules. The system has a clear data flow: the learning unit analyzes past project plan data and classifies content that can be standardized and specific content; the extraction unit automatically extracts content that can be standardized and creates templates; the addition unit analyzes customer requirements and project-specific requirements and adds them to the template; and the generation unit integrates standardized content and specific content to generate a draft project plan. At each stage, the system applies AI models (e.g., Transformer series, CNN, RNN, decision trees, etc.) and algorithms (e.g., natural language processing, clustering, feature extraction, template matching, etc.) to process input data (e.g., text, images, audio, structured data, etc.) in multiple steps. Each module passes the output of the AI model (e.g., feature vectors, scores, templates, addition candidates, etc.) to subsequent modules, enabling threshold judgment, rule-based branching, and immediate reflection in the user interface. As a technical effect, the system, unlike conventional uniform plan creation flows or manual, personalized judgments, achieves efficiency in plan creation, quality standardization, and optimization of knowledge transfer through stepwise and automatic information extraction, classification, integration, and generation by AI. Applicable fields include IT system development, construction, manufacturing, research and development, education, medical care, administrative document creation, and any field requiring project-based work or document generation. Furthermore, since the AI models and algorithms at each stage can be flexibly switched and optimized according to project attributes and user requirements, the system as a whole has high scalability, flexibility, and adaptability. Thus, the system goes beyond mere automation to achieve technical improvement of the plan creation process and overall optimization of operations.

Step 1: The learning unit learns from past project plans. The learning unit analyzes the content of past project plans using generative AI and classifies content that can be standardized and specific content. The generative AI, for example, uses a text generation AI (e.g., LLM) to analyze the content of project plans and distinguish between content that can be standardized, such as project objectives, schedules, and resource allocation, and specific content, such as customer requirements and specific technical requirements. Step 2: The extraction unit extracts content that can be standardized based on the content learned by the learning unit. The extraction unit automatically extracts portions that can be standardized from past plans using generative AI and saves them as templates. The generative AI, for example, uses machine learning algorithms to extract portions that can be standardized from past plans and save them as templates. Step 3: The addition unit adds specific content based on the standardized content extracted by the extraction unit. The addition unit analyzes customer requirements and specific technical requirements using generative AI and adds them to the template. The generative AI, for example, analyzes specific functions or services requested by the customer and technical constraints and adds them to the template. Step 4: The generation unit generates a draft version of a project plan by combining the specific content added by the addition unit with the standardized content. The generation unit combines standardized content and specific content using generative AI to generate a draft version of a project plan. The generative AI, for example, uses a text generation AI to combine standardized content and specific content to generate a draft version of a project plan. Specifically, in Step 1, the system receives past project plan data (e.g., text files, PDFs, structured databases, etc.) as input, extracts features from each section of the plan (e.g., objectives, schedules, resource allocation, requirements, etc.) using natural language processing algorithms (e.g., Transformer encoder, BERT, etc.) and feature extraction algorithms (e.g., TF-IDF, n-gram analysis, section classifier, etc.), and classifies common and specific parts by clustering and similarity calculation. Examples of AI input include “plan data: full text” and “sections: objectives, schedules, resource allocation”. Examples of AI output include structured data such as “common parts: objective=quality improvement, schedule=6 months” and “specific parts: requirements=API integration, customer requirements=enhanced security”. In Step 2, the extraction unit automatically saves the common parts as template data in a template database based on the classification results of the learning unit and creates templates. In Step 3, the addition unit receives customer requirements and specific requirement data (e.g., requirement lists, technical specifications, constraint conditions, etc.) as input, analyzes the requirements using natural language processing algorithms and feature extraction algorithms, and automatically adds them to the template. Examples of AI input include “requirements: cloud integration, enhanced security” and “technical requirements: API design details”. Examples of AI output include prioritized addition data such as “addition candidate: cloud integration function (priority 0.9), enhanced security (priority 0.8)”. In Step 4, the generation unit integrates the template and additional requirements and automatically generates a draft plan using a text generation AI (e.g., autoregressive Transformer). The generated plan is output as a structured document including section structure, explanatory text, charts, and summary of key points. In the internal processing of the AI model, supervised learning, self-supervised learning, transfer learning, and meta-learning are combined at each step, and model parameters are optimized according to project attributes and user requirements. In subsequent processing, the generated plan is passed to the user interface or file output module and proceeds to the review and approval process. As a technical effect, the system, unlike conventional manual plan creation and personalized know-how accumulation, achieves efficiency in plan creation, quality standardization, and optimization of knowledge transfer through stepwise and automatic information extraction, classification, integration, and generation by AI. Applicable fields include IT system development, construction, manufacturing, research and development, education, medical care, administrative document creation, and any field requiring project-based work or document generation. Furthermore, since the AI models and algorithms at each stage can be flexibly switched and optimized according to project attributes and user requirements, the system as a whole has high scalability, flexibility, and adaptability. Thus, the system goes beyond mere automation to achieve technical improvement of the plan creation process and overall optimization of operations.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned learning unit, extraction unit, addition unit, and generation unit is implemented by at least one of, for example, the smart device 14 and the data processing apparatus 12. For example, the learning unit is implemented by a control unit 46A of the smart device 14 or a specific processing unit 290 of the data processing apparatus 12. The extraction unit is implemented, for example, by the specific processing unit 290 of the data processing apparatus 12. The addition unit is implemented, for example, by the control unit 46A of the smart device 14 or the specific processing unit 290 of the data processing apparatus 12. The generation unit is implemented, for example, by the specific processing unit 290 of the data processing apparatus 12. The correspondence between each unit and the device or control unit is not limited to the examples described above and various modifications are possible.

### Second Embodiment

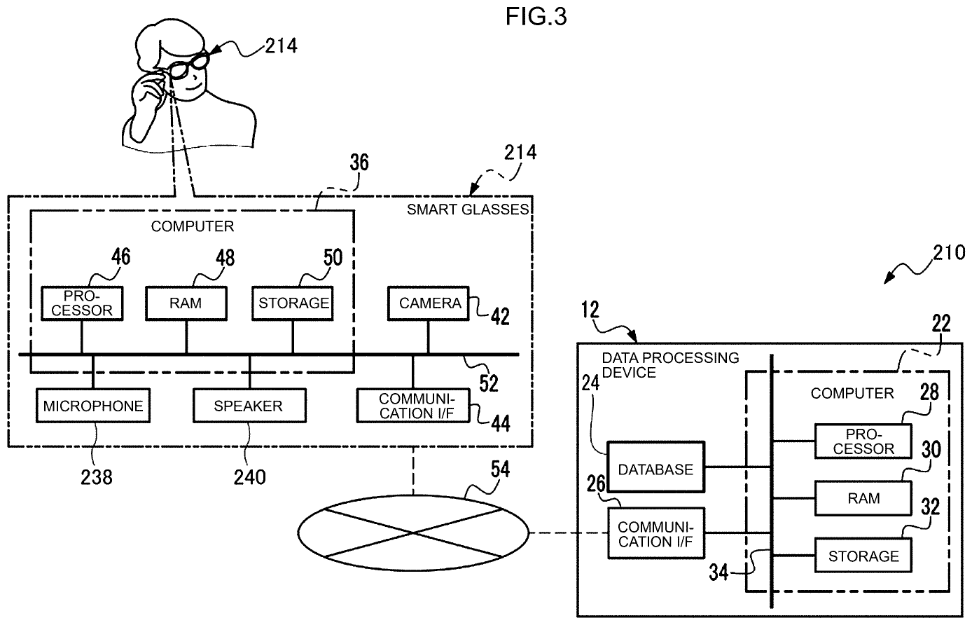

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

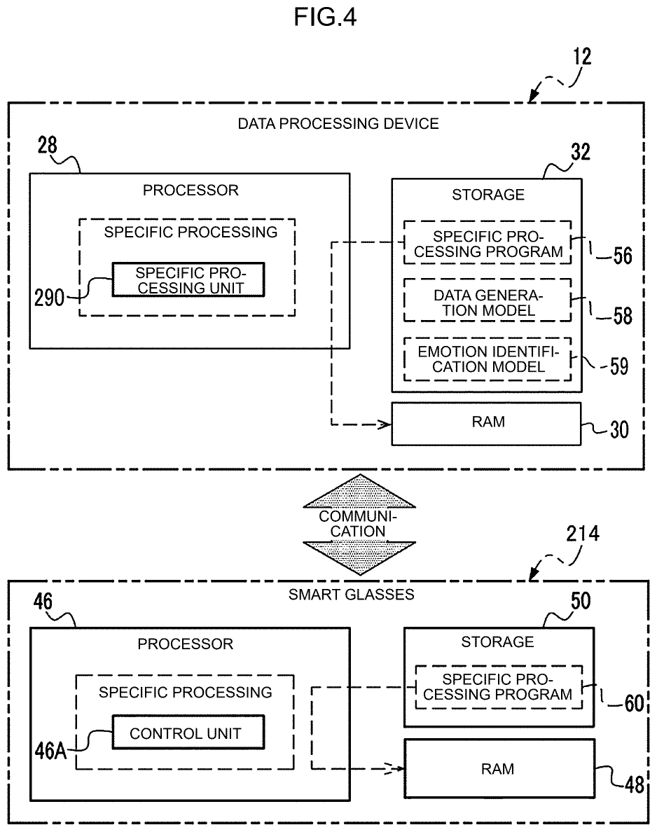

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned learning unit, extraction unit, addition unit, and generation unit is implemented by at least one of, for example, the smart glasses 214 and the data processing apparatus 12. For example, the learning unit is implemented by a control unit 46A of the smart glasses 214 or a specific processing unit 290 of the data processing apparatus 12. The extraction unit is implemented, for example, by the specific processing unit 290 of the data processing apparatus 12. The addition unit is implemented, for example, by the control unit 46A of the smart glasses 214 or the specific processing unit 290 of the data processing apparatus 12. The generation unit is implemented, for example, by the specific processing unit 290 of the data processing apparatus 12. The correspondence between each unit and the device or control unit is not limited to the examples described above and various modifications are possible.

### Third Embodiment

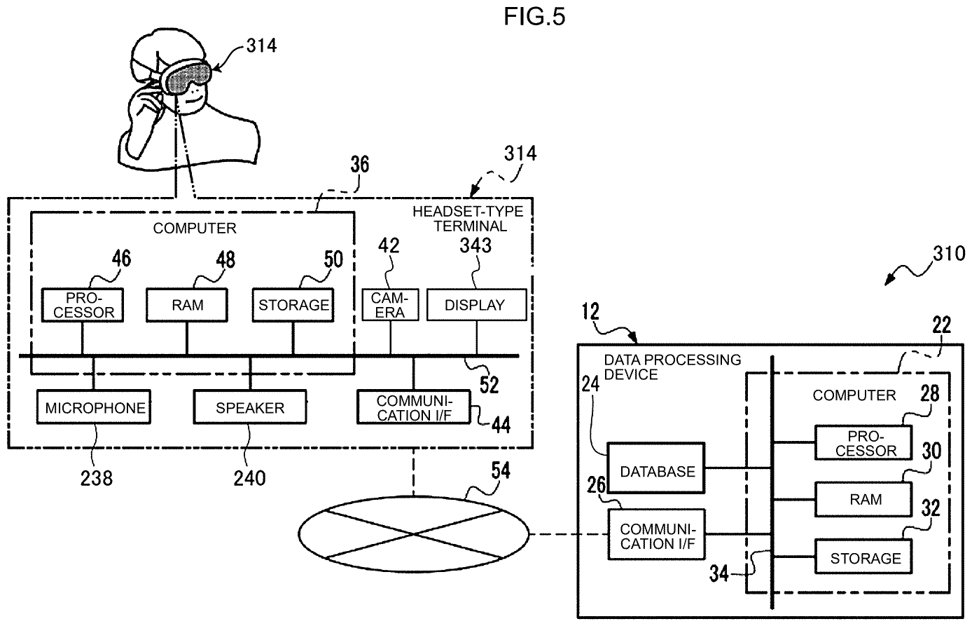

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

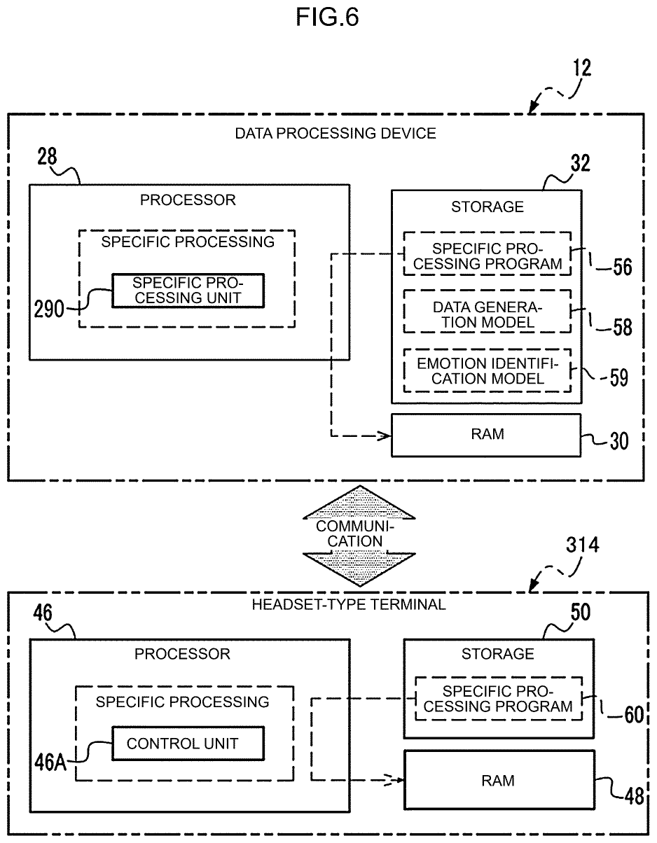

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned learning unit, extraction unit, addition unit, and generation unit is implemented by at least one of, for example, the headset-type terminal 314 and the data processing apparatus 12. For example, the learning unit is implemented by a control unit 46A of the headset-type terminal 314 or a specific processing unit 290 of the data processing apparatus 12. The extraction unit is implemented, for example, by the specific processing unit 290 of the data processing apparatus 12. The addition unit is implemented, for example, by the control unit 46A of the headset-type terminal 314 or the specific processing unit 290 of the data processing apparatus 12. The generation unit is implemented, for example, by the specific processing unit 290 of the data processing apparatus 12. The correspondence between each unit and the device or control unit is not limited to the examples described above and various modifications are possible.

### Fourth Embodiment

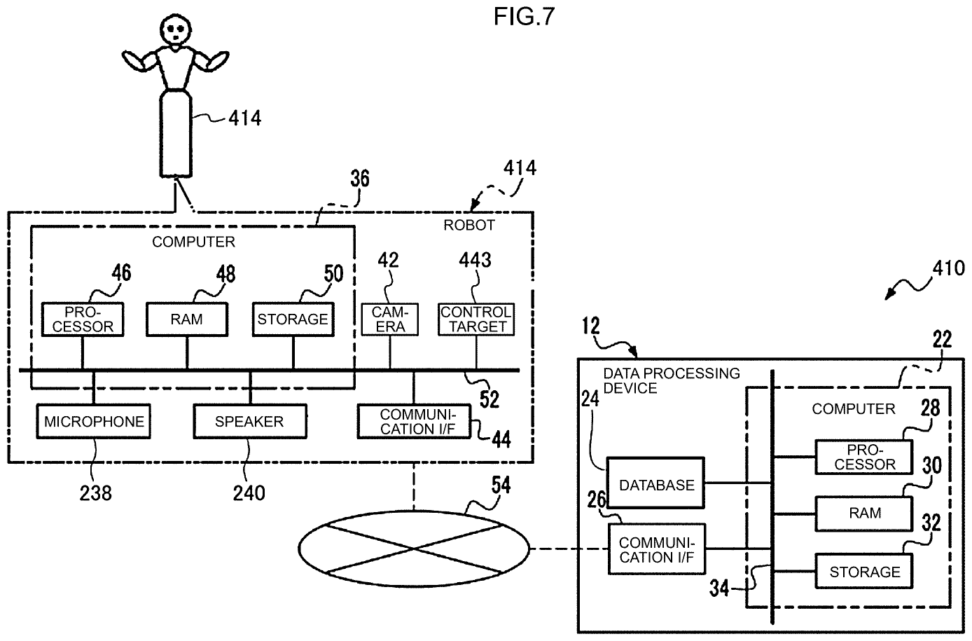

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

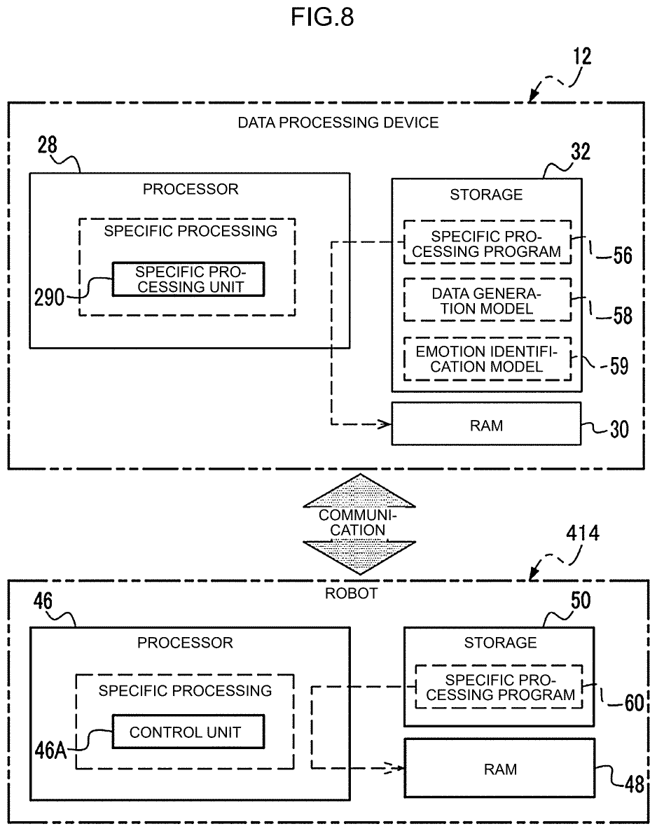

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned learning unit, extraction unit, addition unit, and generation unit is implemented by at least one of, for example, the robot 414 and the data processing apparatus 12. For example, the learning unit is implemented by a control unit 46A of the robot 414 or a specific processing unit 290 of the data processing apparatus 12. The extraction unit is implemented, for example, by the specific processing unit 290 of the data processing apparatus 12. The addition unit is implemented, for example, by the control unit 46A of the robot 414 or the specific processing unit 290 of the data processing apparatus 12. The generation unit is implemented, for example, by the specific processing unit 290 of the data processing apparatus 12. The correspondence between each unit and the device or control unit is not limited to the examples described above and various modifications are possible.

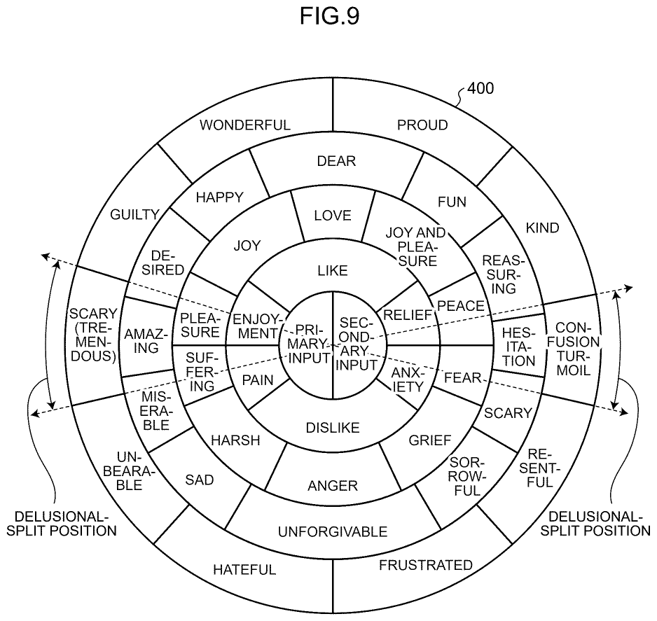

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

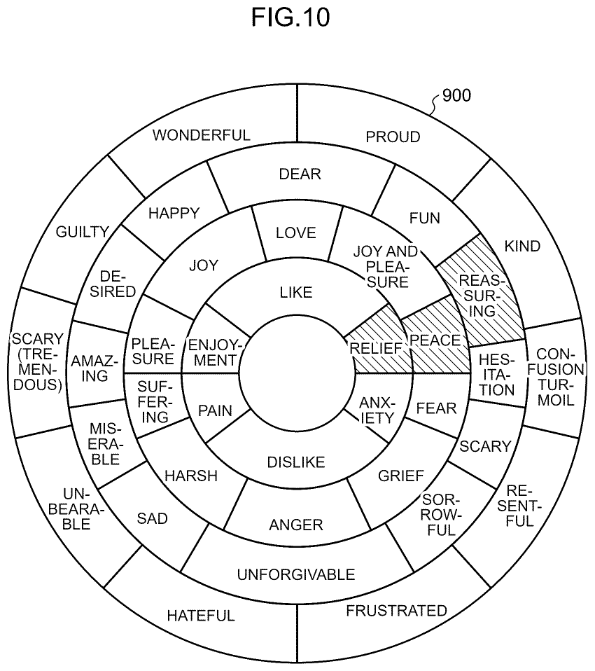

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a learning unit configured to learn from past project plans; an extraction unit configured to extract content that can be standardized based on the content learned by the learning unit; an addition unit configured to add specific content based on the standardized content extracted by the extraction unit; and a generation unit configured to generate a draft version of a project plan by combining the specific content added by the addition unit with the standardized content.
(Supplementary Note 2) The system according to Supplementary Note 1, wherein the learning unit is configured to analyze the content of past project plans.
(Supplementary Note 3) The system according to Supplementary Note 1, wherein the extraction unit is configured to automatically extract portions that can be standardized from past plans and save them as templates.
(Supplementary Note 4) The system according to Supplementary Note 1, wherein the addition unit is configured to analyze customer requirements or specific technical requirements and add them to the template.
(Supplementary Note 5) The system according to Supplementary Note 1, wherein the generation unit is configured to generate a draft version of a project plan by combining standardized content and specific content.
(Supplementary Note 6) The system according to Supplementary Note 1, wherein the generation unit is configured to output the generated draft version.
(Supplementary Note 7) The system according to Supplementary Note 1, wherein the learning unit is configured to estimate a user's emotion and select learning data based on the estimated emotion of the user.
(Supplementary Note 8) The system according to Supplementary Note 1, wherein the learning unit is configured to analyze the success rate of past project plans during learning and learn the characteristics of successful plans.
(Supplementary Note 9) The system according to Supplementary Note 1, wherein the learning unit is configured to apply different learning algorithms according to the scale or industry of the project during learning.
(Supplementary Note 10) The system according to Supplementary Note 1, wherein the learning unit is configured to estimate a user's emotion and adjust the frequency of learning based on the estimated emotion of the user.
(Supplementary Note 11) The system according to Supplementary Note 1, wherein the learning unit is configured to weight learning data based on the progress of the project during learning.
(Supplementary Note 12) The system according to Supplementary Note 1, wherein the learning unit is configured to select learning data in consideration of the geographical distribution of the project during learning.
(Supplementary Note 13) The system according to Supplementary Note 1, wherein the extraction unit is configured to estimate a user's emotion and determine the priority of content to be extracted based on the estimated emotion of the user.
(Supplementary Note 14) The system according to Supplementary Note 1, wherein the extraction unit is configured to analyze the frequency of common portions in past plans during extraction and preferentially extract portions with high frequency.
(Supplementary Note 15) The system according to Supplementary Note 1, wherein the extraction unit is configured to apply different extraction algorithms for each project category during extraction.
(Supplementary Note 16) The system according to Supplementary Note 1, wherein the extraction unit is configured to estimate a user's emotion and adjust the display method of content to be extracted based on the estimated emotion of the user.
(Supplementary Note 17) The system according to Supplementary Note 1, wherein the extraction unit is configured to determine the priority of extraction based on the submission timing of the project during extraction.
(Supplementary Note 18) The system according to Supplementary Note 1, wherein the extraction unit is configured to refer to related literature of the project during extraction to improve extraction accuracy.
(Supplementary Note 19) The system according to Supplementary Note 1, wherein the addition unit is configured to estimate a user's emotion and adjust the expression method of content to be added based on the estimated emotion of the user.
(Supplementary Note 20) The system according to Supplementary Note 1, wherein the addition unit is configured to analyze the customer's past requirement history during addition and select an appropriate addition method.
(Supplementary Note 21) The system according to Supplementary Note 1, wherein the addition unit is configured to apply different addition algorithms according to the customer's industry or scale during addition.
(Supplementary Note 22) The system according to Supplementary Note 1, wherein the addition unit is configured to estimate a user's emotion and determine the priority of content to be added based on the estimated emotion of the user.
(Supplementary Note 23) The system according to Supplementary Note 1, wherein the addition unit is configured to preferentially add highly relevant content in consideration of the customer's geographic location during addition.
(Supplementary Note 24) The system according to Supplementary Note 1, wherein the addition unit is configured to analyze the customer's social media activity during addition and add related content.
(Supplementary Note 25) The system according to Supplementary Note 1, wherein the generation unit is configured to estimate a user's emotion and adjust the expression method of the plan to be generated based on the estimated emotion of the user.
(Supplementary Note 26) The system according to Supplementary Note 1, wherein the generation unit is configured to adjust the level of detail of the plan to be generated based on the importance of the project during generation.
(Supplementary Note 27) The system according to Supplementary Note 1, wherein the generation unit is configured to apply different generation algorithms according to the project category during generation.
(Supplementary Note 28) The system according to Supplementary Note 1, wherein the generation unit is configured to estimate a user's emotion and adjust the length of the plan to be generated based on the estimated emotion of the user.
(Supplementary Note 29) The system according to Supplementary Note 1, wherein the generation unit is configured to determine the priority of the plan to be generated based on the submission timing of the project during generation.
(Supplementary Note 30) The system according to Supplementary Note 1, wherein the generation unit is configured to adjust the order of the plan to be generated based on the relevance of the project during generation.

What is claimed is:

1. A system comprising:
circuitry configured to:
receive, via a communication interface coupled to a packet-switched network, a plurality of structured dataset records from a client terminal;
apply a data generation model comprising a Transformer-based architecture to the plurality of structured dataset records to extract feature vectors representing reusable patterns within the plurality of structured dataset records;
generate template data structures based on the extracted feature vectors by applying at least one of clustering analysis or principal component analysis to identify common elements across the plurality of structured dataset records;
receive, via the communication interface, input parameter data from the client terminal;
merge the input parameter data into the template data structures by vectorizing the input parameter data using the Transformer-based architecture and evaluating relevance scores between the input parameter data and the template data structures;
generate output data by combining the template data structures with the merged input parameter data using the data generation model; and
transmit the output data to the client terminal via the communication interface.

2. The system according to claim 1, wherein the circuitry is further configured to convert the plurality of structured dataset records into token sequences using a natural language processing encoder, and to generate context vectors having a dimensionality of at least 768 from the token sequences using the Transformer-based architecture.

3. The system according to claim 1, wherein the circuitry is further configured to analyze a success metric associated with each of the plurality of structured dataset records, and to weight the feature vectors based on the success metric such that structured dataset records having a higher success metric contribute more to the template data structures.

4. The system according to claim 1, wherein the circuitry is further configured to apply different extraction algorithms according to a category label associated with the plurality of structured dataset records, such that for a first category, the circuitry applies a Transformer-based extraction algorithm, and for a second category, the circuitry applies a decision tree-based extraction algorithm.

5. The system according to claim 1, wherein the circuitry is further configured to analyze a frequency of the common elements across the plurality of structured dataset records using at least one of term frequency-inverse document frequency analysis or n-gram analysis, and to preferentially include common elements having a frequency above a threshold in the template data structures.

6. The system according to claim 1, wherein the circuitry is further configured to classify the input parameter data into functional requirement data and non-functional requirement data using the Transformer-based architecture, and to merge the functional requirement data and the non-functional requirement data into different sections of the template data structures.

7. The system according to claim 1, wherein the circuitry is further configured to analyze a history of past input parameter data associated with a user identifier received from the client terminal, and to select a merging method for the input parameter data based on the history of past input parameter data.

8. The system according to claim 1, wherein the circuitry is further configured to apply different merging algorithms according to an industry attribute or a scale attribute associated with the input parameter data, the different merging algorithms comprising at least one of a deep neural network for large-scale parameter data or a rule-based algorithm for small-scale parameter data.

9. The system according to claim 1, wherein the circuitry is further configured to estimate an emotion of a user by applying an emotion identification model to at least one of facial image data, voice waveform data, or text data received from the client terminal, and to select a subset of the plurality of structured dataset records for the extracting based on the estimated emotion.

10. The system according to claim 9, wherein the emotion identification model comprises a convolutional neural network configured to extract facial features from the facial image data, a recurrent neural network configured to extract prosodic features from the voice waveform data, and a Transformer encoder configured to extract context feature vectors from the text data, and wherein the circuitry is further configured to integrate the facial features, the prosodic features, and the context feature vectors using a multilayer perceptron to output an emotion score.

11. The system according to claim 9, wherein the circuitry is further configured to adjust a level of detail of the output data based on the estimated emotion, such that when the estimated emotion indicates a stress level above a first threshold, the circuitry generates the output data in a simplified format, and when the estimated emotion indicates a concentration level above a second threshold, the circuitry generates the output data in a detailed format.

12. The system according to claim 1, wherein the circuitry is further configured to adjust a level of detail of the output data based on an importance attribute associated with the input parameter data, such that when the importance attribute exceeds a threshold, the circuitry generates the output data with increased granularity.

13. The system according to claim 1, wherein the circuitry is further configured to apply different generation algorithms according to a category of the input parameter data, the different generation algorithms comprising at least one of a pattern-matching model, a large language model for new content generation, or a reinforcement learning model for output optimization.

14. The system according to claim 1, wherein the circuitry is further configured to determine a priority of generating the output data based on a deadline attribute associated with the input parameter data, such that when the deadline attribute indicates a remaining time below a threshold, the circuitry prioritizes generation of the output data.

15. The system according to claim 1, wherein the circuitry is further configured to receive geographic location data associated with the plurality of structured dataset records, and to filter the plurality of structured dataset records based on the geographic location data using a spatial neighbor search algorithm before extracting the feature vectors.

16. The system according to claim 1, wherein the circuitry is further configured to receive reference document data via the communication interface, to compute a semantic similarity between the reference document data and candidate elements of the template data structures using cosine similarity of embedding vectors generated by the Transformer-based architecture, and to include only candidate elements having a semantic similarity above a threshold in the template data structures.

17. The system according to claim 1, wherein the circuitry is further configured to perform a duplicate elimination operation and a consistency verification operation on the merged input parameter data before generating the output data.

18. A system comprising:
circuitry configured to:
receive, via a communication interface coupled to a packet-switched network, a plurality of structured dataset records from a client terminal, each structured dataset record comprising a text portion and a performance indicator portion;
convert the text portion of each structured dataset record into a context vector having a dimensionality of at least 768 using a Transformer-based encoder of a data generation model, and normalize the performance indicator portion into a numerical vector;
extract feature vectors from the context vectors by applying at least one of supervised learning comprising a multilayer perceptron, self-supervised learning comprising contrastive learning, or reinforcement learning for template optimization;
generate template data structures by applying clustering analysis to the extracted feature vectors to identify common elements, and store the template data structures in a database;
receive, via the communication interface, input parameter data from the client terminal;
vectorize the input parameter data using a natural language processing encoder of the data generation model, evaluate relevance scores between the vectorized input parameter data and the template data structures using cosine similarity, classify the input parameter data into at least functional requirement data and non-functional requirement data, and merge the classified input parameter data into corresponding sections of the template data structures;
generate output data by combining the template data structures with the merged input parameter data using the data generation model, the output data comprising at least a structured text document; and
transmit the output data to the client terminal via the communication interface.

19. The system according to claim 18, wherein the circuitry is further configured to analyze a success metric associated with each structured dataset record using at least one of feature importance analysis comprising SHAP values or permutation importance, and to store success feature data derived from the success metric in the database for preferential utilization when generating the output data.

20. A method performed by circuitry of a system, the method comprising:
receiving, via a communication interface coupled to a packet-switched network, a plurality of structured dataset records from a client terminal;
applying a data generation model comprising a Transformer-based architecture to the plurality of structured dataset records to extract feature vectors representing reusable patterns within the plurality of structured dataset records;
generating template data structures based on the extracted feature vectors by applying at least one of clustering analysis or principal component analysis to identify common elements across the plurality of structured dataset records;
receiving, via the communication interface, input parameter data from the client terminal;
merging the input parameter data into the template data structures by vectorizing the input parameter data using the Transformer-based architecture and evaluating relevance scores between the input parameter data and the template data structures;
generating output data by combining the template data structures with the merged input parameter data using the data generation model; and
transmitting the output data to the client terminal via the communication interface.
